(19) United States
(12) Patent Application Publication
(10) Pub. No.: US 2009/0286910 A1
(43) Pub. Date: Nov. 19, 2009

(54) Viscoelastic and Dilatant Composition, Device and Method of Use and Manufacture

(75) Inventor: Louis A. Bloomfield, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(73) Assignee: UNIVERSITY OF VIRGINIA PATENT FOUNDATION, Charlottesville, VA (US)

(21) Appl. No.: 12/302,358

(22) PCT Filed: May 25, 2007
(86) PCT No.: PCT/US07/12572

§ 371 Date: Nov. 25, 2008

Related U.S. Application Data
(60) Provisional application No. 60/808,869, filed on May 26, 2006.
(60) Provisional application No. 60/830,276, filed on Jul. 12, 2006.
(60) Provisional application No. 60/899,862, filed on Feb. 6, 2007.

(51) Int. Cl. H01B 3/20; C08K 5/5419

(52) U.S. Cl. 524/269; 524/267

(57) ABSTRACT

A device and related method having an elastic means and a damping means for controlling motion between objects or bodies. The elastic means and the damping means may be combined together to form a composite material, for which there is a method of use and manufacture. The device and related method may also utilize a dilatant-based material to oppose the rapid relative motion of two members. The objects or bodies, for example, may be a piece of furniture and the floor. In its application to furniture, this device and related method acts to keep all the legs on a piece of furniture in contact with the floor so that there is no rocking, and it acts to make those legs rigid on short timescales so that there is no bouncing or apparent unsoundness of the support.

### CROSS-REFERENCE TO RELATED APPLICATIONS

The present invention claims priority under 35 U.S.C. § 119(e) of the earlier filing date of U.S. Provisional Application Ser. No. 60/808,869, filed May 26, 2006, entitled “Self-Adjusting, Anti-Rock Legs and Other Restraints and Related Method thereof;” U.S. Provisional Application Ser. No. 60/830,276, filed Jul. 12, 2006, entitled “Anti-Rock Furniture Feet and Restraining Devices Using Dilatant Lubricants and Related Method Thereof;” and U.S. Provisional Application Ser. No. 60/899,862, filed Feb. 6, 2007, entitled “Self-Adjusting, Anti-Rock Legs and Other Restraints and Related Method thereof,” of which all the disclosures are hereby incorporated by reference herein in their entirety.

### BACKGROUND OF THE INVENTION

Rocking tables and chairs are a familiar part of everyday life. While three-legged stools rest firmly on the ground, four-legged chairs and tables tend to rock, particularly when placed on uneven floors. Unless all four legs contact the floor simultaneously, the chair or table will rock whenever its overall center of gravity shifts beyond a “tipping point” and it has to bring a new trio of legs into contact with the floor in order to support itself.

Although such rocking behavior may be a pleasant distraction to a young child, adults generally find it a nuisance or worse. Restaurant and café tables that rock are not merely irritating; they are hazardous. Beverages and foods often spill as a table rocks, and fingers and toes can be pinched as the table teeters from one trio of legs to another.

The rocking problem is a consequence of the physics governing static stability. A piece of furniture is in a stable equilibrium only when its center of gravity is located vertically above its base of support—the polygon that forms when the points at which it contacts the floor are connected by line segments. When the piece's center of gravity is no longer above that base of support, the piece becomes unstable and begins to tip. If that tipping produces new contact points with the floor and a new base of support, the piece may arrive at a new stable equilibrium. This transition from one stable equilibrium to another stable equilibrium by way of a limited tipping motion is what we mean by “rocking.”

There are three long-established general solutions to the rocking furniture problem. The first solution is to limit pieces of furniture to three legs. But while a three-legged stool or table cannot rock in our three-dimensional world, it can tip over altogether. In effect, a three-legged piece of furniture avoids the rocking problem by tipping over instead. That's hardly an improvement. Moreover, limiting furniture designs to three legs is impractical and undesirable.

Another solution is to carefully adjust the leg lengths on a piece of furniture so that all of its legs contact the floor simultaneously. The piece won't rock then because its base of support extends to all of its legs and it has only one stable equilibrium. But even the most careful leg-length adjustment is only temporary. Moving the piece, exposing it to temperature or humidity variations, and even the passage of time alone can spoil the leg adjustment and allow the piece to begin rocking again. Almost any piece of furniture with four or more legs will rock to some extent on a hard floor. Although rocking can be stopped temporarily by shimming the piece's legs with pieces of paper, sugar packets, or wooden wedges, or by readjusting their lengths, it will reappear as soon as the piece of furniture is disturbed.

Another solution is to make the piece of furniture and/or its legs elastic so that its weight brings all of the legs into contact with the floor simultaneously. With its legs perpetually touching the floor, the piece cannot rock. But this absence of rocking comes at a price: the piece can now bounce. Bouncing is often worse than rocking; tables and chairs that bounce back and forth after being disturbed are as likely to spill food or pinch fingers as those that rock. Moreover, a piece of furniture that is supported elastically has a soft, unsteady feel—it yields easily to relatively gentle forces and seems wobbly or rickety.

Examples of other devices are (A) automobile suspensions, in which an elastic spring establishes the stable equilibrium and a damping shock absorber dissipates energy stored in the spring by a road bump so as to dampen oscillations about the stable equilibrium, and (B) hydraulic door closers, in which an elastic spring establishes the stable equilibrium and a hydraulic shock absorber dissipates energy stored in that spring by the act of opening the door so as to slow the door's return to its closed equilibrium.

Further, lubricants have focused on easing the relative motions of two surfaces as they slide across one another and protecting those two surfaces from wear. Anti-lubricants have focused on preventing the relative motions of two surfaces that are trying to slide across one another. Timescales have entered into the consideration of lubricants and anti-lubricants only in the sense that lubricants are expected to ease motion and suppress wear over the timescales important to the lubricated systems and anti-lubricants are expected to prevent relative motions over the timescales important to the anti-lubricated systems. Viscosity has only entered into considerations of lubricants and anti-lubricants in the context of keeping them in place so that they provide good lubrication and wear protection (lubricants) or good anti-lubrication (anti-lubricants).

### BRIEF SUMMARY OF THE INVENTION

An aspect of an embodiment of this invention solves the furniture rocking problem by adjusting leg lengths automatically and continually. Unlike the first solution discussed in the background section, this invention allows a piece of furniture to have more than three legs without risk of rocking. Unlike the second solution, this invention requires no manual adjustment or readjustment of leg length in order to eliminate rocking. Unlike the third solution, this invention gives the piece of furniture a firm, sturdy, non-bouncy feel. A piece of furniture employing this invention always behaves as though the length of each of its legs was carefully adjusted, for example, a few seconds earlier.

In its application to furniture, this invention (1) gradually lengthens a leg that is bearing little or no weight, (2) gradually shortens a leg that is bearing excessive weight, and (3) opposes any sudden changes in leg length. This invention acts to keep all the legs on a piece of furniture in contact with the floor so that there is no rocking, and it acts to make those legs rigid on short timescales so that there is no bouncing or apparent unsoundness of the support.

An aspect of an embodiment of this invention is a linear support means comprised of an elastic means and a damping means wherein the linear support (1) responds to changes in applied stress by slowly changing its length in order to approach equilibrium on a long timescale and (2) acts to oppose any short-timescale change in its length.

An aspect of an embodiment of this invention is a rotary support means comprised of an elastic means and a damping means wherein the rotary support means (1) responds to changes in applied rotary stress by slowly rotating in order to approach rotational equilibrium on a long timescale and (2) acts to oppose any short-timescale change in its angular orientation.

An aspect of various embodiments of the present invention covers, among other things, composite materials that combine an elastic means and a damping means in a single material. Such a material is known as a Kelvin-Voigt material. There are many advantages to manifesting both means in a single material: (1) the material can be incorporated into devices of any size and shape without having to be reengineered, (2) there is intrinsic redundancy of the elastic means and damping means in the material so that it is extremely unlikely to fail, (3) its structural simplicity makes engineering and construction relatively easy, and (4) it allows for great spatial uniformity in the responses to stresses and shear stresses.

An aspect of various embodiments of the present invention covers, among other things, composite materials in which the damping means is partly or wholly dilatant. Such shear-thickening behavior is an essential feature of bouncing putty. A composite material that combines an elastic means and a dilatant damping means in a single material has an important additional advantage: (5) it strongly opposes sudden or short-timescale changes in length, thickness, or shape, while offering much weaker opposition to gradual or long-timescale changes. In effect, its Young's modulus and its shear modulus both depend on timescale and both increase as the timescale for measurement decrease.

An aspect of various embodiments of the present invention covers, among other things, dilatant lubricants, materials that ease the relative motions of two surfaces as they slide across one another at long timescales while opposing the relative motions of two surfaces that are trying to slide across one another at short timescales. At all timescales, the dilatant lubricant protects those two surfaces from wear. In other words, this invention covers the use of dilatant materials when they are employed as agents between surfaces with the intention of having those materials act as lubricants at long timescales and as anti-lubricants at short timescales.

Dilatant lubricants give rise to an important type of damping means: when two surfaces slide across one another, separated by a dilatant lubricant, their motion is weakly damped at long timescales but strongly damped at short timescales. The two surfaces slide across one another easily if their relative speed is slow but experience severe opposition if their relative speed is fast.

An aspect of various embodiments of the present invention also covers, among other things, the use of dilatant lubricants when a volume of a dilatant lubricant is caused to slide across a surface, and the surface and lubricant experience viscous drag forces. This arrangement gives rise to another important type of damping means: when a volume of dilatant lubricant slides across a surface, their relative motions are weakly damped at long timescales but strongly damped at short timescales. The dilatant lubricant slides across the surface easily if their relative speed is slow but they experience severe opposition if their relative speed is fast.

An aspect of various embodiments of the present invention additionally covers, among other things, devices that combine elastic means and dilatant-lubricant-based damping means when those devices have the following three characteristics: (1) the role of the elastic means is to act together with an applied stress to establish a stable equilibrium, (2) to allow that stable equilibrium to shift to a new location in response to a change in the applied stress, and (3) the role of the damping means is to oppose the device's motion from the original stable equilibrium to the new stable equilibrium. In other words, such a device responds elastically to applied stress on long timescales but it is rigid on short timescales.

For example, an aspect of this invention covers any linear support means comprised of an elastic means and a dilatant-lubricant-based damping means wherein the linear support (1) responds to changes in applied stress by slowly changing its length in order to approach equilibrium on a long timescale and (2) acts to oppose any short-timescale change in its length. It also covers any rotary support means comprised of an elastic means and a dilatant-lubricant-based damping means wherein the rotary support means (1) responds to changes in applied rotary stress by slowly rotating in order to approach rotational equilibrium on a long timescale and (2) acts to oppose any short-timescale change in its angular orientation. This invention also covers any rotary support means in which the dilatant-lubricant-based damping means is present but the elastic means is absent. In this latter case, the device always rotates slowly in response to rotary stress because the dilatant-lubricant-based damping means acts to oppose any short-timescale change in the device's angular orientation. In other words, slow rotation is permitted, but fast rotation is not.

In the context of anti-rock furniture feet and other restraining devices, this invention covers the use of dilatant-lubricant-based damping means to oppose rapid linear motions and rapid hinging motions. When that damping means is combined with an elastic means, the result is a system that (a) slowly elongates or opens when there are no external forces or torques acting on it, (b) slowly shortens or closes when there are strong external forces or torques acting on it, and (c) strongly opposes sudden changes in its length or the extent of its opening.

An aspect of the various embodiments of the present invention also facilitates load sharing among the legs. When a piece of furniture with traditional legs is placed on a hard floor, most of that furniture's weight is supported by only two or three of its legs. Even when that piece's legs have been adjusted to prevent rocking, some of those legs bear relatively little weight. This invention helps to distribute the piece's weight more evenly among the legs. No matter how many legs the piece of furniture has, each leg will help to support it.

An aspect of the various embodiments of the present invention is that composite materials that are both the elastic means and the damping means can be fabricated in any size or shape and can therefore facilitate load sharing in ways that are spatially uniform or nearly uniform. A properly shaped embodiment consisting in whole or part of one or more composite materials could support an extended object having any degree of shape complexity so as to reduce its tendency to wobble, flex, or break. Placing such an embodiment between two bodies ensures that the pressure forces pushing those two bodies apart are distributed relatively evenly on long timescales while providing those bodies with stiff short timescale support.

An aspect of the various embodiments of the present invention is that composite materials that are both the elastic means and the damping means can also have adhesive properties and can bind two bodies together while simultaneously reducing their tendencies to wobble, flex, or break. Placing such an embodiment between two bodies ensures that the pressure forces pulling those two bodies together are distributed relatively evenly on long timescales while providing them with stiff short timescale support.

Some exemplary novel aspects associated with various embodiments of the present invention include, but are not limited thereto, the following:
1. provides a linear or rotary support means that is self-adjusting on long timescales but rigid on short timescales.
2. eliminates rocking in a piece of furniture or other body by continually and automatically adjusting the lengths of its legs to keep them in contact with the floor.
3. eliminates bounciness, wobbliness, and ricketiness in a piece of furniture or other body by providing firm leg support on short time scales.
4. distributes the weight of a piece of furniture or other body among its legs or segments of other bodies.
5. provides a way to oppose rapid linear, hinging, and rotary motions and govern their speeds.
6. provides a way to slow or prolong the activation process for mechanical devices such as self-adjusting wedges, spacers, clamps, seals, and gaskets.
7. provides a way to even out the distribution of pressure between two bodies (objects) while providing those bodies (objects) with firm support on short timescales.

These and other objects, along with advantages and features of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1 provides a schematic illustration of an anti-rock leg.

FIG. 2 provides a schematic illustration of a generalized linear embodiment.

FIG. 3 provides a schematic illustration of a generalized rotary embodiment.

FIG. 4 provides a schematic illustration of an anti-rock leg embodiment in which a spring is placed within dilatant putty and the pair is encapsulated in a flexible shell.

FIG. 5 provides a schematic illustration of an anti-rock leg embodiment in which dilatant putty is encapsulated in an elastic shell.

FIG. 6 provides a schematic illustration of an anti-rock leg embodiment in which a spring operates in parallel to a liquid-filled shock absorber.

FIG. 7 provides a schematic illustration of an anti-rock leg embodiment in which a spring is contained within a liquid-filled shock absorber.

FIG. 8 provides a schematic illustration of an anti-rock leg embodiment of this invention in which a composite material acts as both elastic means and damping means.

FIG. 9 provides a schematic illustration of an embodiment of this invention comprising composite material in communication with a first body and a second body.

FIG. 10 provides a schematic illustration of the addition of a hard stop to the anti-rock leg.

FIG. 11 provides a schematic illustration of the addition of a protective case.

FIG. 12 provides a schematic illustration of the restructuring of the invention into a rigid leg and an anti-rock foot.

FIG. 13 provides a schematic illustration of the addition of a bypass system to allow the characteristics of the damping means to be adjusted.

FIG. 14 provides a schematic illustration wherein the elastic means and/or the damping means are subdivided into two or more pieces.

FIG. 15 provides a schematic illustration of an embodiment comprising a first member in contact and movement with a second member wherein each member may be in contact with one or more bodies.

FIG. 16 provides a schematic illustration of the concept of a linear embodiment of this invention as an anti-rock foot for furniture.

FIGS. 17(A)-(E) provide schematic illustrations of detail of a linear embodiment of this invention as an anti-rock foot for furniture.

FIG. 18 provides a schematic illustration of the concept of a hinged embodiment of this invention as an anti-rock foot for furniture.

FIGS. 19(A)-(D) provide schematic illustrations of detail of a hinged embodiment of this invention as an anti-rock foot for furniture.

FIGS. 20(A)-(C) provide schematic illustrations of a straight embodiment of this invention wherein a trapped volume of dilatant lubricant acts as a damping means.

FIGS. 21(A)-(C) provide schematic illustrations of a folded embodiment of this invention wherein a trapped volume of dilatant lubricant acts as a damping means.

The embodiments shown in FIGS. 20 & 21 can be substituted into the concept drawing of FIG. 16 to act as an anti-rock foot for furniture or other desired or required object.

FIG. 22 provides a schematic illustration of a rotational embodiment of this invention. A rotating component (e.g., “rotor”) resides in a stationary component (e.g., “stator”).

### DETAILED DESCRIPTION OF THE INVENTION

### Exemplary, Non-limiting Vocabulary

Stress* the inward force exerted on an object by its environment.
Strain* the stress-induced inward change in an object's length. * Stress and strain are not divided by equilibrium length in my definition of these quantities.
Spring a device in which the stress and strain are proportional to one another.
Generalized Spring a device in which the stress and strain increase together but not necessarily in proportion to one another.
Dashpot a device in which the stress and the time derivative of strain are proportional to one another.
Generalized Dashpot a device in which the stress and the time derivative of Strain increase together but not necessarily in proportion to one another.
Thixotropic Material a material that exhibits shear-thinning behavior; its viscosity decreases as its shear rate increases.
Dilatant Material a material that exhibits shear-thickening behavior; its viscosity increases as its shear rate increases.
Lubricant a material that can be inserted between two surfaces to ease sliding motion and reduce frictional wear.
Anti-lubricant a material that can be inserted between two surfaces to prevent sliding motion.
Dilatant Lubricant a material that acts as a lubricant on long timescales and an anti-lubricant on short timescales.
Leg a portion or component of a piece of furniture, appliance, or other object that is intended to convey that object's weight to the surface on which the object rests; synonymous with foot.
Foot a portion or component of a piece of furniture, appliance, or other object that is intended to convey that object's weight to the surface on which the object rests; synonymous with leg.
Viscous drag the damping forces that arise when a viscous fluid acts to slide across a surface, originating in both surface friction and viscous forces within the fluid.
Composite material a material composed of two or more distinct materials so that it is homogenous at macroscopic length scales but exhibits an underlying inhomogeneous structure at microscopic length scales.

### A.1. Overview

An aspect of various embodiments of the present invention includes any composite material comprising viscous material dispersed in elastomer material. The viscous material can be a dilatant material, and more specifically, a silicon-based dilatant material. The viscous material, for example, can be any one or more of the following: silicone-based material; white glue and borax (or boric acid); polyvinyl alcohol, water, and borax (or boric acid); starch and water; starch, water, and borax (or boric acid); silica nanoparticles in ethylene glycol (or another liquid); copolymer dispersions; or oil/water/polymer emulsions. The viscous material can be dispersed in an elastomer via spontaneous phase separation, via mechanical separation, or via a combination of spontaneous phase separation and mechanical separation. The viscous material can be dispersed in, for example, particulates, threads, layers, or pockets, or any combination of these. This covers all the possible dimensionalities of the viscous material pieces: 0-dimensional (particulates), 1-dimensional (threads), 2-dimensional (layers), and 3-dimensional (pockets). The dispersion of the viscous material in the elastomer material can also be stabilized or facilitated by at least one surfactant.

The elastomer material may be a meltable, thermoplastic elastomer, such as, for example, styrene butadiene styrene (SBS) elastomer, styrene isoprene styrene (SIS) elastomer, or styrene ethylbutylene styrene (SEBS) elastomer. The elastomer material may also be a thermoset elastomer. The elastomer material may also be a cureable material. For example, it can be a material that transforms from liquid-like to solid-like by way of chemical processes other than vulcanization, such as, for example, silicone rubber, fluorosilicone rubber, and polyurethane (PU) elastomer. The elastomer material may also be vulcanizable. Such vulcanizable material can be, for example, classic rubber, natural rubber, or silicone rubber.

One example embodiment includes a silicone-based viscous material comprising heat treated silanol-terminated silicone oil (for example, Gelest DMS-S27), boric acid, and 5 micron silica; and an elastomer material comprising styrene ethylbutylene styrene (SEBS) rubber (for example, Kraton G-1657). Another example embodiment includes a silicone-based viscous material comprising heat treated silanol-terminated silicone oil (for example, Gelest DMS-S27), boric acid, and 5 micron silica; and an elastomer material comprising polyurethane (PU) elastomer (for example, Freeman 1040).

When a thermoplastic elastomer is used, the composite material can be made by melting the elastomer material and mixing it with the viscous material. The mixing techniques include dispersive mixing in an injection screw, including a conventional screw, a pineapple mixing section, a Saxton mixing section, a wave-type screw section, a Twente mixing section, a blister mixing section, a Maddock/LeRoy mixing section, a Z-shaped fluted mixing section, an elongated pin mixing section, a CRD mixing section, and/or a Lameller mixing section, with layer multiplication. The mixing can also be done by dispersive mixing to form virgin composite pellets.

When a thermoset elastomer is used, the method of making the composite comprises providing at least one precursor material, dispersing the viscous material into the precursor material, and transforming the precursor material into an elastomer material. The dispersion can be done by, for example, at least one of the following: mixing, cutting and mixing, grinding and mixing, powdering and mixing, and pulverizing and mixing. Pulverizing and powdering, for example, can be done with the use of a wire brush at high speeds. The addition of surfactant to stabilize one component may also be utilized. When a thermoset elastomer is used, the transforming can comprise one or both of polymerizing and cross-linking the precursor material. This may occur, for example, at room temperature or at a higher temperature. In an approach, a method of manufacturing the composite material as discussed throughout may include thermally annealing in its final shape to improve its viscoelastic characteristics and performance.

The material used and the proportions used should be determined by considering speed control concepts. The long timescale stiffness should be set by the firmness of the elastomer material and the mixture ratio. The short timescale stiffness should be set by the firmness of the viscous material and the mixture ratio.

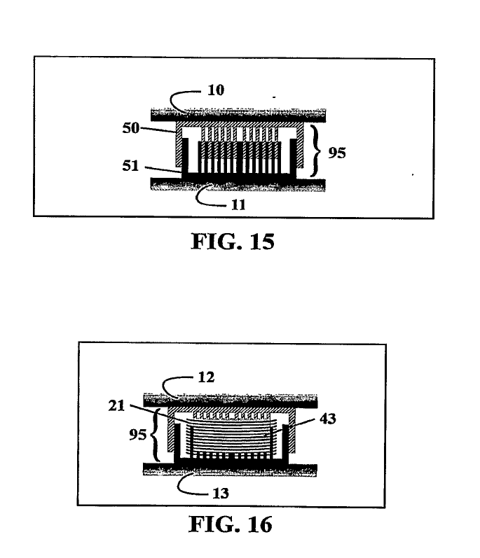

An alternative embodiment of this invention is a device for opposing rapid relative motion. The device comprises at least two members in contact with one another. An example of this alternative embodiment appears in FIG. 15. The device 95 is comprised of a first member 50 and a second member 51 that may be in communication with a first body 10 (or force) and second body 11 (or force). One or more of the members comprises a dilatant-lubricant-based material. The dilatant-lubricant-based material can coat one or more of the members. The dilatant-lubricant-based material can also be dispersed in one or more of the members to form a composite material. The two or more members can have flat surfaces rubbing against each other. The two or more members may include interdigitating units. The members may also oppose rotary motion. In the rotary embodiment, one member may be a tube or pipe and the other member may be a cylinder or another pipe.

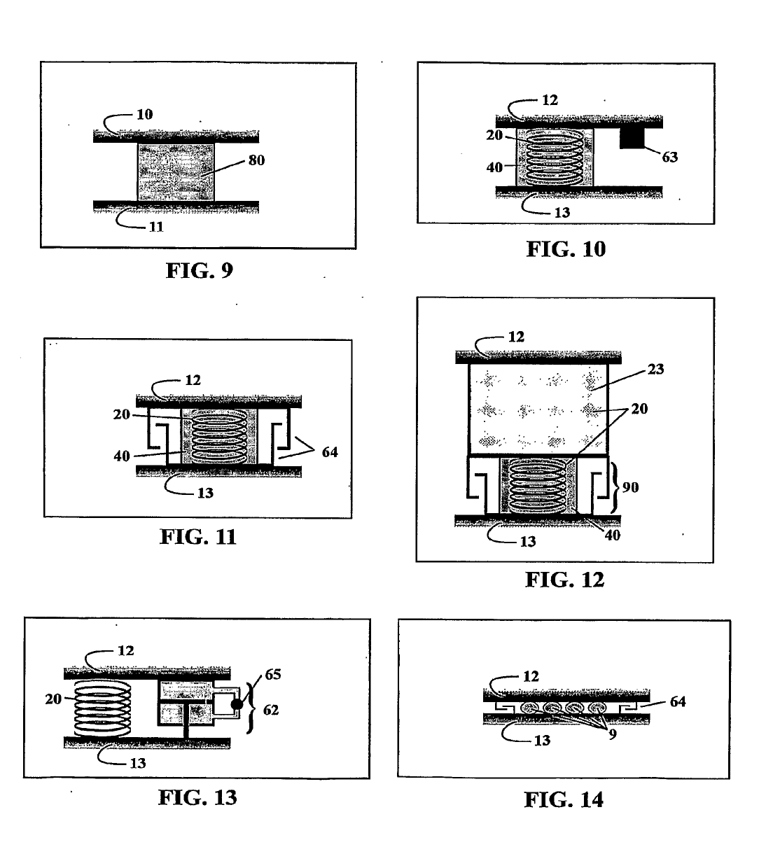

The composite material and the device for opposing rapid relative motion can have many uses. The composite material or the device may be in communication with one or more bodies. As shown in FIG. 9, the composite material 80 may be in communication with a first body 10 (or force) and a second body 11 (or force). Similarly, as shown in FIG. 15, the device 95 may be in communication with a first body 10 and a second body 11. For example, as in FIG. 8, the composite material 80 may be in communication with a piece of furniture 12 (or force) and the floor 13 (or force). The two or more bodies may also be a combination of the following: floor, ground, wall, piece of furniture, appliance, container, household equipment, commercial equipment, industrial equipment, art object, vehicle, computer, electronic device, cart, dolly, camera, camera mount, door, door frame, window, window frame, motor, fan, transformer, ballast, automobile component, ratchet, cargo, shoe, lever, switch, button, subfloor, inner wall, tile, marble, granite, slate, or wood or any desired or required object or force. The first body may also be cargo with the second body being whatever may come into contact with the cargo. The communication between the bodies can also be mediated by at least one of a container, shell, holder, retainer, clip, clamp, housing, guard, spring, or covering or the like. In addition, the container, shell, holder, retainer, clip, clamp, housing, guard, spring, or covering may contribute to the elastic or viscous character of the composite or both. For example, an elastic shell may enclose the composite material, contributing to its elastic behavior, and may help the composite material rebound after long compressions.

Additionally, the composite material may also serve as an adhesive, for example, in attaching floor or wall treatment, such as ceramic tiles, marble, granite, slate, oak planks, or any hard material, to a subfloor or an inner wall, or object.

An aspect of an embodiment of the present invention provides a meltable rubber that one can mix with a viscous putty to form a viscoelastic emulsion—a true Kelvin-Voigt material. In an embodiment a rubber-putty emulsion can be created there from.

An aspect of an embodiment of the present invention provides high-performance silicone putties. For example, commercial Silly Putty® has been optimized as a toy, not as the “damping means” for the present invention. An aspect of a version of the present invention is a silicone putty that is much stronger and tougher and therefore better for a table (or the like) stabilizer and other uses. An aspect of the invention provides a concentrated composite material so that it only takes a small piece to stabilize a table.

An aspect of an embodiment of the present invention provides a material that may possibly cost about $5/pound to produce in industrial quantities. For instance, if 5 grams are enough to stabilize a table leg, then each leg should cost 5 cents to make and be simple to make via injection molding, rolling, or extrusion. In an embodiment, the material may be approximately:
50.0% Thermoplastic Elastomer (for example, Kraton G-1657) at $2-3/pound;
23.3% Silanol-Terminated Silicone Oil (for example, Gelest DMS-S27) at $3-7/pound;
1.7% Boric Acid at $3-7/pound; and
25.0% Powdered Silica at $3-5/pound.

An aspect of an embodiment of the present invention provides processing that may involve forming the putty at about 200° C. over several hours, drying it to remove moisture created in the putty-forming reaction, hot mixing with the elastomer, and finally making pellets for later injection molding, rolling, or extrusion. An embodiment provides a material that shall be extremely stable and shall work properly anywhere on earth, from coldest to hottest environments. In fact, it can function properly even in boiling water.

An aspect of an embodiment of the present invention provides a device that has the feel of a stiff puck on short timescales and a soft puck on long timescales. In other words, its long-timescale stiffness and its short-timescale stiffness are different. Basically, the pucks (or other shaped devices) may be approximately 25-75% putty and the balance elastomer. That elastomer may be a thermoplastic elastomer, such as styrene butadiene styrene (SBS), styrene isoprene styrene (SIS), or styrene ethylbutylene styrene (SEBS), or it may be a curing or thermoset elastomer, such as silicone rubber. The device may vary regarding the softness characteristics (long-timescale stiffness) and stiffness characteristics (short-timescale stiffness). Some embodiments may be cast as donut-shaped or multiple-hole disks to get better compression behavior and more side-to-side stability. Some embodiments may provide true vulcanized rubbers due to their increased resistance to “compression set.” An embodiment may include dispersing the right putty in the right unvulcanized rubber and then casting them and vulcanizing them into particularly tough, functional stable legs.

Some exemplary novel aspects of various embodiment of the present invention may provide, but are not limited thereto, the following:
1. This material is a true Kelvin-Voigt material.
2. This material is a composite material combining a dilatant material (such as silicone putty) with a meltable rubber to form a viscoelastic emulsion so that rather than having two separate materials this may be one composite material.
3. This material is scalable and easy to make and form by injection molding, rolling, or extrusion.
4. This material has a very wide temperature range. It should be stable in all temperature ranges commonly found on Earth.

An aspect of various embodiments of the present invention solves the rocking problem by adjusting leg lengths automatically and continually, so that a piece of furniture employing this invention always behaves as though the length of each of its legs was carefully adjusted a few seconds earlier. This invention (1) gradually lengthens a leg that is bearing little or no weight, (2) gradually shortens a leg that is bearing excessive weight, and (3) opposes any sudden changes in leg length. This invention acts to keep all the legs on a piece of furniture in contact with the floor so that there is no rocking, and it acts to make those legs rigid on short timescales so that there is no bouncing or apparent unsoundness of the support.

Any time a piece of furniture is mentioned it can be any body or object as desired or required. Moreover, anytime leg is mentioned it may be a segment or portion of the body or object.

The elastic means behaves as a generalized spring: its stress and strain increase together. This elastic means is responsible for supporting the piece of furniture on long timescales, meaning that when the situation is static or nearly so, the elastic means will support the leg's portion of the piece's weight. That portion of weight acts as a stress on the elastic means and causes the elastic means to undergo strain. The equilibrium length of the elastic means decreases as the portion of weight the leg supports increases.

The damping means behaves as a generalized dashpot: its stress and the time derivative of its strain increase together. The damping means is responsible for opposing sudden changes in leg length. The damping means stiffens the leg's response to sudden or transient stresses so that the leg is much firmer at short timescales than it is at long timescales. On short timescales, the damping means can be viewed as participating in supporting the leg's portion of the piece's weight: the damping means provides positive support when the leg is shortening and negative support when the leg is lengthening.

Combining these two elements gives the leg different behaviors on two different timescales. On long timescales the elastic means dominates the leg's behavior: the leg responds to an increase in the amount of weight it supports by becoming shorter and to a decrease in the amount of weight it supports by becoming longer. On short timescales, the damping means dominates the leg's behavior: the leg's length barely changes in response to changes in the amount of weight it supports. The leg provides relatively soft, elastic support on long timescales and firm, rigid support on short timescales.

In other words, when the elastic means is combined with the damping means, the result is a system that (a) slowly elongates or opens when there are no external forces or torques acting on it, (b) slowly shortens or closes when there are strong external forces or torques acting on it, and (c) strongly opposes sudden changes in its length or the extent of its opening.

Negative forces or torques simply reverse the directions of motion: the system (a) slowly shortens or closes when there are no external negative forces or torques acting on it, (b) slowly lengthens or opens when there are strong negative external forces or torques acting on it, and (c) strongly opposes sudden changes in its length or the extent of its opening.

When a piece of furniture (or other object) with anti-rock legs is first placed on the floor, its legs begin to shorten. Whenever one of the legs contacts the floor and starts bearing weight, its length decreases. Given time to reach equilibrium, the piece's legs will all come into contact with the floor and each leg will bear a portion of weight that is directly related to its decrease in length. Together, those self-adjusted legs will exert just the right upward forces to support the piece's weight and keep it in a stable equilibrium.

That equilibrium depends, however, on the piece's weight, its center of gravity, and on any external forces exerted on the piece. A change in one of these quantities will lead to a change in the piece's equilibrium. Once the equilibrium changes, the lengths of the piece's legs will gradually self-adjust in order to reach that new equilibrium. Upon arrival at that equilibrium, the legs will again exert just the right upward forces to support the piece's weight plus any external forces and keep the piece in a stable equilibrium.

The arrival at a new equilibrium occurs in the limit of long times and is therefore governed by the long timescale (elastic) behavior of the anti-rock legs. The departure toward a new equilibrium, however, can occur suddenly and is therefore governed by the short timescale (damping) behavior of the anti-rock legs. By opposing motion toward the new equilibrium, the anti-rock legs give the piece of furniture a firmness and solidity of support that would be absent with purely elastic legs.

Because the piece's anti-rock legs remain in contact with the floor throughout the self-adjustment process whereby the piece shifts to a new equilibrium following a change in weight, center of gravity, or external force, there is no tipping point and no rocking motion. Because the piece's anti-rock legs oppose motion and severely delay the transition to a new equilibrium, there is no bouncing and the piece feels firmly and soundly supported.

Among the embodiments of this invention are those that employ dilatant-lubricant-based damping means to oppose rapid linear motions and rapid hinging motions. Each dilatant-lubricant anti-rock leg is comprised of two elements, an elastic means and a dilatant-lubricant-based damping means. Though conceptually distinct, these two elements may or may not be structurally separate in their implementations. In particular, many dilatant lubricants have small elastic components to their stress-strain relationships and respond elastically to very weak stresses. Moreover, many elastic materials have small damping components to their stress-strain relationships and respond inelastically in some situations. The purpose of the anti-rock leg is both to support its piece of furniture primarily by way of its elastic means and to prevent that piece from rocking primarily by way of its damping means.

An aspect of the various embodiments of the present invention also facilitates load sharing among the legs. When a piece of furniture with traditional legs is placed on a hard floor, most of that furniture's weight is supported by only two or three of its legs. Even when that piece's legs have been adjusted to prevent rocking, some of those legs bear relatively little weight. This invention helps to distribute the piece's weight more evenly among the legs. No matter how many legs the piece of furniture has, each leg will help to support it.

### A.2. Conceptual Details

### A.2.1 The Elastic Means

The elastic means has been identified so far only as a generalized spring, meaning that this invention encompasses all elastic means in which the stress and strain increase together. There are, however, several specific types of elastic means that are particularly appropriate for certain purposes. Those types are non-exclusive, meaning that a single elastic means may exemplify more than one of those types. Those types and the purposes associated with them are enumerated below.
1. Type of Elastic Means: An elastic means that exhibits an abrupt and dramatic to rise in stress when its strain exceeds a specific value.
   Purpose: To limit the descent of a piece of furniture so that the furniture remains at or above a certain height regardless of how much extra weight or downward forces are added to it.
   Explanation: This abrupt rise in stress can be viewed as “bottoming out”—the elastic means has been shortened to its minimum allowed length and fiercely opposes any further shortening. This bottoming out feature can be designed into the elastic means expressly or allowed to arise spontaneously; since an elastic means cannot have a negative length, it must exhibit this bottoming out behavior eventually. The strain at which this bottoming out occurs establishes the leg's minimum length and therefore the piece of furniture's minimum height. This bottoming out effect doesn't impair the anti-rock properties of the legs: all of the piece's legs continue to contact the floor and any transition to a new equilibrium will occur gradually, without rocking or bouncing. In fact, bottoming out is often desirable because a bottomed-out leg can support great weight. It will frequently be the case that a four-legged table supported on anti-rock feet will have three of its feet bottomed out and the fourth operating between its minimum and maximum lengths so as to prevent rocking.
2. Type of Elastic Means: An elastic means in which the stress and strain are approximately proportional to one another over a broad range of strains and that reaches a stress somewhat in excess of its fair share of the furniture weight just before it “bottoms out.”
   Purpose: To distribute the weight of the piece of furniture relatively evenly among that piece's legs.
   Explanation: When the piece is first placed on its legs, all those legs will shorten extensively and by similar amounts. Since for this type of elastic means the stress is approximately proportional to strain, the legs will experience nearly equal stresses and will provide nearly equal supports to the piece of furniture, even as they prevent rocking and bouncing. The piece will reach equilibrium before the legs “bottom out,” a valuable feature because a bottomed-out leg would bear more than its fair share of the piece's weight.
3. Type of Elastic Means: An elastic means consisting of two parts: a relatively long rigid strut and a relatively short elastic part. The stress versus strain behavior of this elastic means is determined almost entirely by the short elastic part.
   Purpose: To allow ordinary furniture legs to be transformed into anti-rock furniture legs or to allow an anti-rock leg to be divided structurally into a rigid leg and an anti-rock foot.
   Explanation: Existing pieces of furniture, as well as future pieces based on conventional designs, can be given anti-rock legs by combining conventional legs with anti-rock feet. The elastic means in such a composite leg has two parts: the rigid strut of the conventional leg and the elastic portion of the anti-rock foot. To avoid altering the height of the piece of furniture significantly when anti-rock feet are added to its conventional legs, those anti-rock feet must be relatively short and have a relatively narrow range of possible lengths. As long as the anti-rock feet have enough range of adaptation to accommodate imperfections in the floor and the piece, piece will not rock and will not bounce.
4. Type of Elastic Means: An elastic means in which the stress increases faster than linearly with respect to strain. For example, the stress may approximate a polynomial function of the strain where the degree of that polynomial function exceeds one, or the stress may approximate an exponential function of the strain.
   Purpose: To allow the anti-rock leg to provide a wide range of supporting forces over a relatively small range of leg lengths.
   Explanation: Some pieces of furniture (e.g., chairs) must accommodate relatively dramatic changes in weight without correspondingly dramatic changes in leg length. The anti-rock legs used with these pieces need a wide dynamic range of stress while having small dynamic range of strain. This requirement can be achieved by using an elastic means that exhibits a stress that depends exponentially or as a polynomial of degree greater than one on strain.
5. Type of Elastic Means: An elastic means that attaches to the floor so as to be able to experience negative stresses (i.e., tensile stress).
   Purpose: To provide a piece of furniture with anti-rock characteristics while also preventing it from tipping over.
   Explanation: Anti-rock legs that merely touch the floor (i.e., do not attach to the floor) will prevent a piece of furniture from rocking but will not prevent it from tipping over. If the piece's center of gravity shifts out from above that piece's base of support, the piece will tip over. If the anti-rock legs attach to the floor and can thus experience negative stresses (i.e., tensile stresses), however, the anti-rock legs will continue to support the piece and prevent rocking even when the piece's center of gravity shifts out from above the piece's base of support.

### A.2.2 The Damping Means

The damping means has been identified so far only as a generalized dashpot, meaning that its stress and the time derivative of its strain increase together. There are, however, several specific types of damping means that are particularly appropriate for certain purposes. Those types are non-exclusive, meaning that a single damping means may exemplify more than one of those types. Those types and the purposes associated with them are enumerated below.
1. Type of Damping Means: A dilatant material in which the stress increases faster than linearly with respect to the time derivative of strain (e.g., the stress may approximate a polynomial function of the time derivative of strain where the degree of that polynomial function exceeds one or the stress may approximate an exponential function of the time derivative of the strain).
   Purpose: To prevent the furniture from moving significantly in response to sudden forces or torques.
   Explanation: A virtue of this nonlinear behavior is that the anti-rock leg exhibits extreme opposition to sudden changes in length and thereby provides particularly firm support at short timescales. The dilatant damping will provide only small opposition to slow changes in leg length but extreme opposition to fast changes in leg length.
2. Type of Damping Means: A viscous lubricant that opposes relative motion between two surfaces sliding across one another.
   Purpose: To slow the rate at which a furniture leg changes length while using relatively little damping material.
   Explanation: Since friction is primarily a surface phenomenon, damping means based on lubricants needs only a superficial layer of damping material.

### A.3. EMBODIMENTS

### A.3.1 The Elastic Means

The elastic means is a generalized spring and can be realized in myriad ways. Components that can comprise the elastic means individually or in groups of two or more include, but not limited thereto:
1. A helical coil compression spring
2. A tapered helical coil compression spring
3. A wave spring
4. A leaf spring
5. An elastomeric spring (i.e., a sphere, cube, cylinder, shell, disk, or other shape made of elastomers)
6. A torsional spring
7. A spiral coil spring
8. A gas-filled piston and cylinder
9. A flexible, gas-filled shell
10. An elastic, liquid-filled shell
11. Repulsion between magnets
   In addition, there are many components that cannot comprise the elastic means individually but that can be incorporated along with elastic components to form composite elastic means. Components that can be incorporated in composite elastic means include, but not limited thereto:
1. Rigid struts (e.g., conventional furniture legs)
2. Columns
3. Levers
4. Beams
5. Braces
6. Pivots
7. Axles
8. Pulleys
9. Cords
10. Screws

### A.3.2 The Damping Means

The damping means is a generalized dashpot and can be realized in myriad ways. Components that can comprise the damping means individually or in groups of two or more include:

### A.3.2.1 Dilatant-Lubricant-Based Damping Means

The damping means can be realized using dilatant lubricants. Such dilatant-lubricant-based damping means include, but are not limited thereto:
1. Two or more solid surfaces separated by dilatant lubricant so that the lubricant experiences shear stress as the surfaces act to slide across one another. Multiple surfaces may be interdigitated.
2. One or more solid projections (cylindrical, rectangular, curved, or any other geometric shape), passing into mating slots or holes and separated from those slots or holes by dilatant lubricant so that the lubricant experiences shear stress as the projections act to enter or leave the holes.
3. One or more mating systems, each equivalent to a piston and cylinder arrangement, in which the piston-like component squeezes dilatant lubricant out of the cylinder-like component through gaps separating the piston and cylinder so that the lubricant experiences shear stress.
4. Two or more solid surfaces, separated by a cloth, paper, woven fabric, nonwoven fabric, or other porous material that has been impregnated with dilatant lubricant.
5. A trapped volume of dilatant lubricant that is required to slide through an enclosure. The dilatant lubricant is effectively a piston and the enclosure is effectively a cylinder. As the lubricant/piston moves through the enclosure/cylinder, the two experience highly speed-dependent viscous drag forces.

In addition, there are many components that cannot comprise the damping means individually but that can be incorporated along with components that can to form composite damping means. Components that can be incorporated in composite damping means include, but not limited thereto:

1. Rigid struts (e.g., conventional furniture legs)

2. Columns

3. Levers

4. Beams

5. Braces

6. Pivots

7. Axles

8. Pulleys

9. Cords

10. Screws

A vast variety of dilatant materials can be used as or incorporated in the dilatant-lubricant-based damping means. Some dilatant materials, however, are particularly useful when embodying anti-rock legs. These dilatant materials include, but not limited thereto:
1. Silicone putty (e.g., dimethyl siloxane- and poly(dimethyl siloxane)-based substances such as Silly Putty®, Dow Corning 3179 Dilatant Compound, and Dow Corning Q2-3233 Bouncing Putty)
2. White glue and borax (or boric acid)
3. Polyvinyl alcohol, water, and borax (or boric acid)
4. Starch and water
5. Starch, water, and borax (or boric acid)
6. Silica nanoparticles in ethylene glycol (or another liquid)
7. Copolymer dispersions
8. Oil/water/polymer emulsions

### A.3.2.2 Component-of-a-Composite-Material Damping Means

The damping means can be realized within a composite material that also incorporates all or part of the elastic means by incorporating a viscous or dilatant component within that composite material. Such viscous or dilatant components include, but are not limited thereto:
1. Silicone putty (e.g., dimethyl siloxane- and poly(dimethyl siloxane)-based substances such as Silly Putty®, Dow Corning 3179 Dilatant Compound, and Dow Corning Q2-3233 Bouncing Putty)
2. White glue and borax (or boric acid)
3. Polyvinyl alcohol, water, and borax (or boric acid)
4. Starch and water
5. Starch, water, and borax (or boric acid)
6. Silica nanoparticles in ethylene glycol (or another liquid)
7. Copolymer dispersions
8. Oil/water/polymer emulsions

### A.3.3 Combined Elastic-Damping Means

It is nearly impossible to create an elastic means that exhibits zero damping or a damping means that exhibits zero elasticity. This invention encompasses any device in which the elastic means and the damping means are not fully distinguished from one another.

Furthermore, this invention encompasses any device in which the elastic means and the damping means are incorporated into a composite material or in which the elastic means and the damping means are incorporated into a single structure, even when they are not a single material.

### A.3.4 A Complete Anti-Rock Leg

An aspect of various embodiments of the present invention encompasses any furniture leg when that leg is comprised of an elastic means and a damping means that is dilatant-lubricant-based and/or part of a composite material so that it (1) gradually lengthens when it is bearing little or no weight, (2) gradually shortens when it is bearing excessive weight, and (3) opposes any sudden changes in length. Such legs suppress rocking while avoiding bouncing. Such legs also allow a piece of furniture's weight to be distributed relatively evenly on all of its legs.

### Embodiment a.1

### Anti-Rock Leg Concept

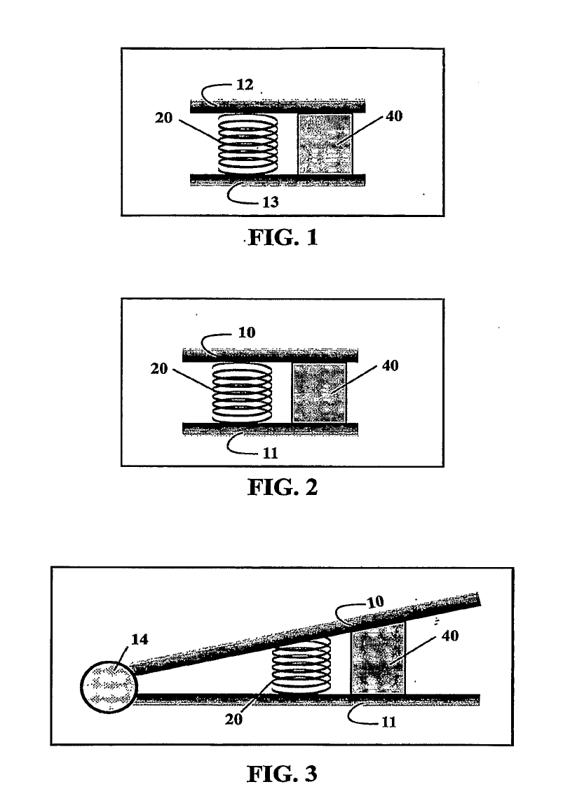

A conceptual embodiment is shown in FIG. 1. This invention encompasses any device comprised of an elastic means 20 and a damping means 40 that is dilatant-lubricant-based and/or part of a composite material when those two means act in parallel between one or more bodies, for example, a piece of furniture 12 and the floor 13 so that they experience the same strain while sharing the stress. On long timescales, the elastic means 20 experiences all of the stress. On short timescales, the damping means 40 also experiences stress and acts to oppose changes in strain.

### Embodiment a.2

### Generalized Linear Concept

A generalized linear conceptual embodiment is shown in FIG. 2. This invention encompasses any device comprised of an elastic means 20 and a damping means 40 that is dilatant-lubricant-based and/or part of a composite material that (1) gradually lengthens when the stress it experiences is small, zero, or negative, (2) gradually shortens when the stress it experiences is large, (3) opposes any sudden changes in length, and (4) is intended to provide relatively soft elastic support on a long timescale and relatively firm support on a short timescale. As shown, the elastic means 20 and the damping means 40 are in communication with a first body 10 and a second body 11.

### Embodiment a.3

### Generalized Rotary Concept

A generalized rotary conceptual embodiment is shown in FIG. 3. This invention encompasses any device comprised of an elastic means 20 and a damping means 40 that is dilatant-lubricant-based and/or part of a composite material that (1) gradually rotates in one direction when the rotary stress it experiences is small, zero, or negative, (2) rotates in the other direction when the rotary stress it experiences is large, (3) opposes any sudden changes in angular orientation, and (4) is intended to provide relatively soft elastic support on a long timescale and relatively firm support on a short timescale. As shown, the elastic means 20 and the damping means 40 are in communication with a first body 10 and a second body 11. Rotation is facilitated by, for example, a pivot 14.

### Embodiment b.1

### Spring-Putty

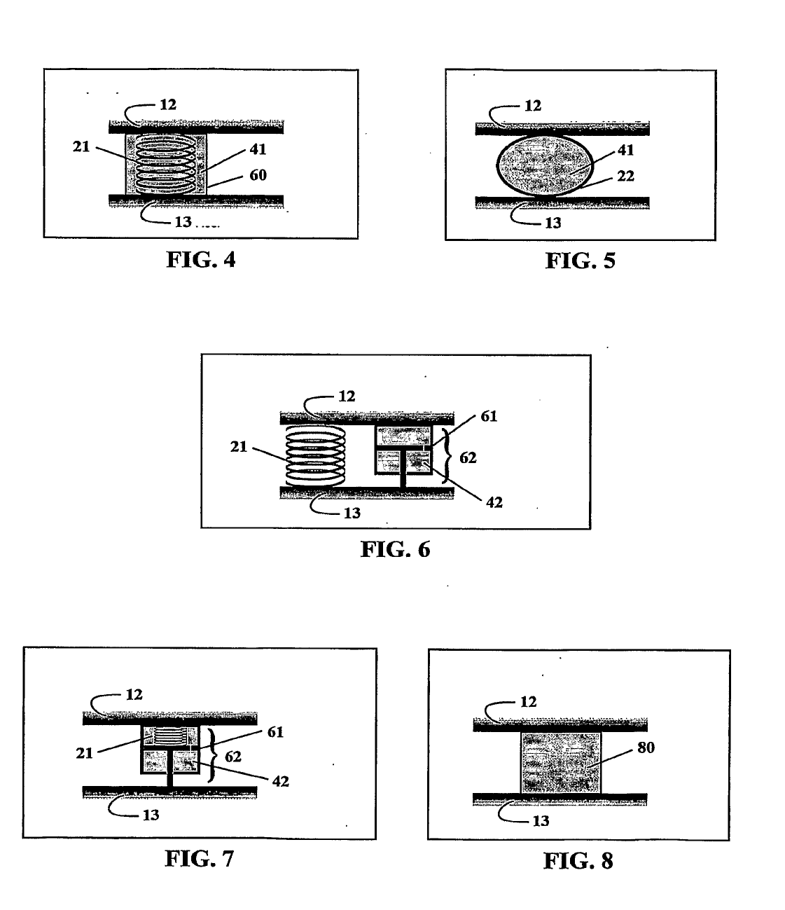

The spring-putty embodiment shown in FIG. 4 uses a spring 21 to realize the elastic means and a dilatant putty 41 to realize the damping means. The spring 21 is located within the putty and the combined system is encapsulated in a flexible shell 60. As shown, the flexible shell 60 may be in communication with one or more bodies, for example, a piece of furniture 12 and the floor 13.

The spring 21 can take many possible forms, including but not limited to a helical coil compression spring, a tapered helical coil compression spring, a wave spring, an elastomeric spring, and a gas-filled shell.

The dilatant putty 41 can take many possible forms, including but not limited to a silicone putty, a white glue and borax putty, a starch and water putty, a starch, water, and borax putty, a polyvinyl alcohol, water, and borax putty, and a silicon nanoparticle and ethylene glycol putty. The phrase “dilatant putty” is synonymous with “dilatant material”; the use of the word “putty” simply recognizes the physical nature or “feel” of a dilatant material.

Although the flexible shell's 60 main purpose is to encapsulate and protect the spring 21 and dilatant putty 41, it may act elastically and therefore supplement the spring 21. In such a case, the actual elastic means is comprised of both the spring 21 and the flexible shell 60.

On long timescales, the spring dominates the behavior of this embodiment: the spring lengthens as the stress it experiences decreases and shortens as the stress it experiences increases. On short timescales, the dilatant putty dominates the behavior of this embodiment: the dilatant putty opposes rapid changes in length.

Although this embodiment can be extended by substituting any other viscous or viscoelastic material for the dilatant putty, the use of a dilatant material gives the embodiment a firmer behavior on short timescales than would a viscous or thixotropic material.

### Embodiment b.2

### Elastic-Shell-Putty

The elastic-shell-putty embodiment shown in FIG. 5 uses an elastic shell 22 to realize the elastic means and a dilatant putty 41 to realize the damping means. The dilatant putty 41 is encapsulated by the elastic shell 22. As shown, the elastic shell 22 may be in communication with one or more bodies, for example, a piece of furniture 12 and the floor 13.

The elastic shell 22 can be any hollow elastic object, with any overall equilibrium shape, any wall-thickness, and constructed of any material that exhibits elastic properties, including but not limited to: natural and synthetic rubbers, metals, plastics, ceramics, glasses, and glass-ceramics. The elastic shell 22 may also be comprised of multiple materials.

The dilatant putty 41 can take many possible forms, including but not limited to a silicone putty, a white glue and borax putty, a starch and water putty, a starch, water, and borax putty, a polyvinyl alcohol, water, and borax putty, and a silicon nanoparticle and ethylene glycol putty.

On long timescales, the elastic shell dominates the behavior of this embodiment: the elastic shell lengthens as the stress it experiences decreases and shortens as the stress it experiences increases. On short timescales, the dilatant putty dominates the behavior of this embodiment: the dilatant putty opposes rapid changes in length.

Although this embodiment can be extended by replacing the dilatant putty with any other viscous or viscoelastic material, the use of a dilatant material gives the embodiment a firmer behavior on short timescales than would a viscous or thixotropic material.

### Embodiment b.3

### Spring-Shock-Absorber, Version 1

The spring-shock-absorber embodiment, version 1, shown in FIG. 6 uses a spring 21 to realize the elastic means and a shock absorber 62 to realize the damping means. As shown, the spring 21 and shock absorber 62 may be in communication with one or more bodies, for example, a piece of furniture 12 and the floor 13.

The spring 21 can take many possible forms, including but not limited to a helical coil compression spring, a tapered helical coil compression spring, a wave spring, an elastomeric spring, a leaf spring, a torsional spring, and a gas-filled shell.

The shock absorber 62 can take many possible forms and can use any damping concept that causes its stress and the time derivative of its strain to increase together. One embodiment of this shock absorber is a piston with leak 61 that moves through a reservoir of viscous liquid 42 when the shock absorber's strain changes. Viscous effects cause this device to exhibit the required relationship between stress and the time derivative of the strain. The nature of the fluid used in the shock absorber, the nature of the piston's leak, and the possibility of added pipes and valves (including one-way valves) allow the shock absorber to exhibit any conceivable relationship between stress and the time derivative of strain.

On long timescales, the spring dominates the behavior of this embodiment: the spring lengthens as the stress it experiences decreases and shortens as the stress it experiences increases. On short timescales, the shock absorber dominates the behavior of this embodiment: the shock absorber opposes rapid changes in length.

This embodiment is particularly appropriate for use with heavy furniture or equipment, where the relative sophistication of a shock absorber is warranted by the need for great strength and adjustability. Together with bypass systems (see embodiment d.4 below), this embodiment provides load-sharing, anti-rock characteristics, and short-timescale firmness.

### Embodiment b.4

### Spring-Shock-Absorber, Version 2

The spring-shock-absorber embodiment, version 2, shown in FIG. 7 uses a spring 21 to realize the elastic means and a shock absorber 62 to realize the damping means. This embodiment differs from embodiment b.3 in that the spring 21 is contained inside the shock absorber 62. As previously stated, this invention encompasses any device in which the elastic means and the damping means are incorporated into a single structure. In this embodiment, the shock absorber 62 contains a piston with leak 61 that moves through a reservoir of viscous liquid 42, which contains a spring 21. As shown, the shock absorber 62 may be in communication with one or more bodies, for example, a piece of furniture 12 and the floor 13

On long timescales, the spring dominates the behavior of this embodiment: the spring lengthens as the stress it experiences decreases and shortens as the stress it experiences increases. On short timescales, the shock absorber (not counting the spring contained inside it) dominates the behavior of this embodiment: the shock absorber opposes rapid changes in length.

### Embodiment b.5

### Composite Material

The composite material embodiment, shown in FIG. 8 uses a composite material 80 to realize both the elastic means and the damping means. This invention encompasses any device in which the elastic means and the damping means are both realized in whole or part together in a composite material. As shown, the composite material 80 may be in communication with one or more bodies, for example, a piece of furniture 12 and the floor 13. More generally, as shown in FIG. 9, the composite material 80 may be in communication with a first body 10 and a second body 11.

This embodiment has the behavior required by the invention. On long timescales, the composite material's elastic character dominates the behavior of this embodiment: the composite material lengthens as the stress it experiences decreases and shortens as the stress it experiences increases. On short timescales, the composite material's damping character dominates the behavior of this embodiment: the composite material opposes rapid changes in length.

### Embodiment b.6

### Linear Dilatant-Lubricant-Based Anti-Rock Leg

Referring to FIG. 16, a linear dilatant-lubricant-based anti-rock leg device 95 is provided. A compression spring 21 comprising the primary elastic means and a set of interdigitating cylinders impregnated with dilatant lubricant 43 comprising the primary damping means act in parallel between the piece of furniture 12 (or body) and the floor 13 (or body) so that they experience the same strain while sharing the stress. On long timescales, the spring 21 experiences the stress. On short timescales, the dilatant-lubricant-based damping means 43 also experiences stress and acts to oppose changes in strain.

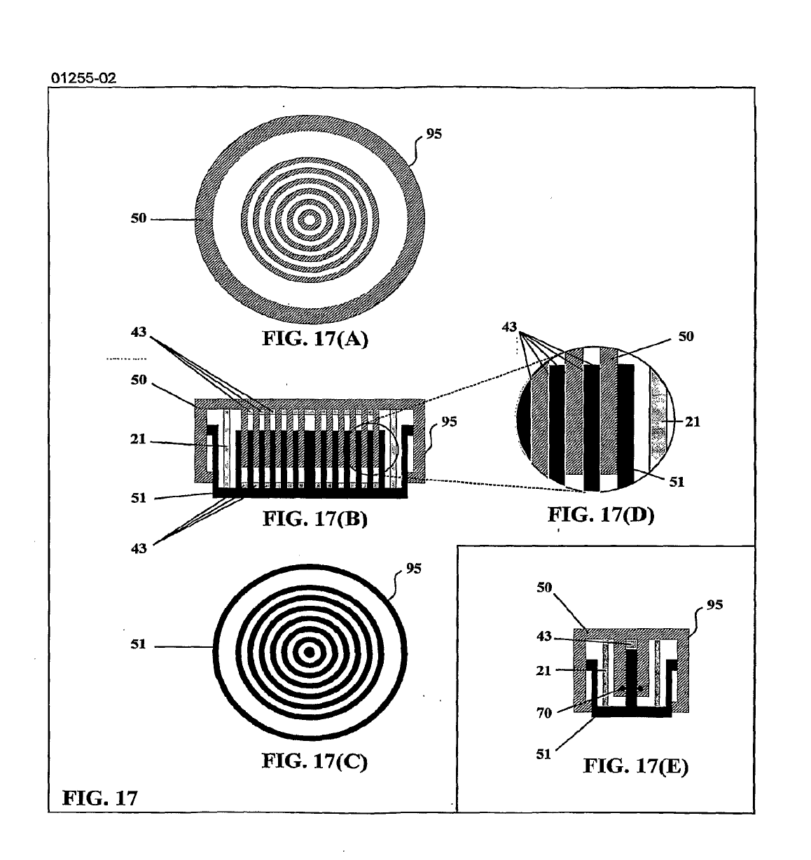

Referring to FIGS. 17(A)-(D), the detail for an example linear dilatant-lubricant-based anti-rock leg device 95 is provided. The example device 95 includes a first member 50 and a second member 51. It may also contain a spring 21 and dilatant lubricant 43. FIG. 17(A) provides a bottom plan view of the bottom surface of first member 50. FIG. 17(B) provides an elevational view. FIG. 17(C) provides a top plan view of the top surface of second member 51. FIG. 17(D) provides an enlarged partial view of FIG. 17(B).

This linear embodiment is well-suited to furniture pieces with vertical legs because it works best when it experiences purely compressive forces due to the weight of the furniture piece and loads borne by that piece.

This embodiment also illustrates several other important innovations that are part of this invention:

First, the two-piece case itself is a secondary part of the elastic means. Although the case does not contribute to the stress-strain relationship when it is between its minimum and maximum extension, it provides stiff inward forces when it reaches its maximum extension and stiff outward forces when it reaches its minimum extension.

The stiffness associated with minimum extension comes about because the upward projections from the case's bottom, second member 51, and the downward projections from the case's top, first member 50, simultaneously encounter obstacles at the minimum extension. Those obstacles are actually extra dilatant lubricant that is inserted into the space just inside the case top's upper surface and the case bottom's lower surface. The encounters between the projections and the extra dilatant lubricate not only provides a dramatic increase in outward force that effectively stops the case from shortening further, it also propels dilatant lubricant into the gaps between the cylindrical projections in the leg. The leg therefore reaches its minimum length and relubricates itself at the same time. This relubricating effect substantially increases the number of operating cycles that the leg can complete before experience a shortage of dilatant-lubricant-based damping.

The stiffness associated with maximum extension comes about because the outer cylinders of the top 50 and bottom 51 are interlocking. Once assembled, interlocking projections prevent the two case components, top and bottom, from coming apart.

To keep the dilatant lubricant in the interdigitating cylinders, the outermost cylinder pair mates tightly to seal in the lubricant.

A variant of this embodiment, Embodiment b.6a, appears in FIG. 17(E). The example device 95 still includes a first member 50 and a second member 51, and may include a spring 21. In this variant, an o-ring 70 seal keeps dilatant lubricant 43 trapped in a piston-cylinder arrangement. Each time the leg “bottoms out” (i.e., it reaches minimum length), the piston propels dilatant lubricant 43 into the gap between piston and cylinder. This routine reapplication of dilatant lubricant 43 to the gap ensures strong damping over many cycles of the embodiment.

### Embodiment b.7

### Hinged Dilatant-Lubricant-Based Anti-Rock Leg

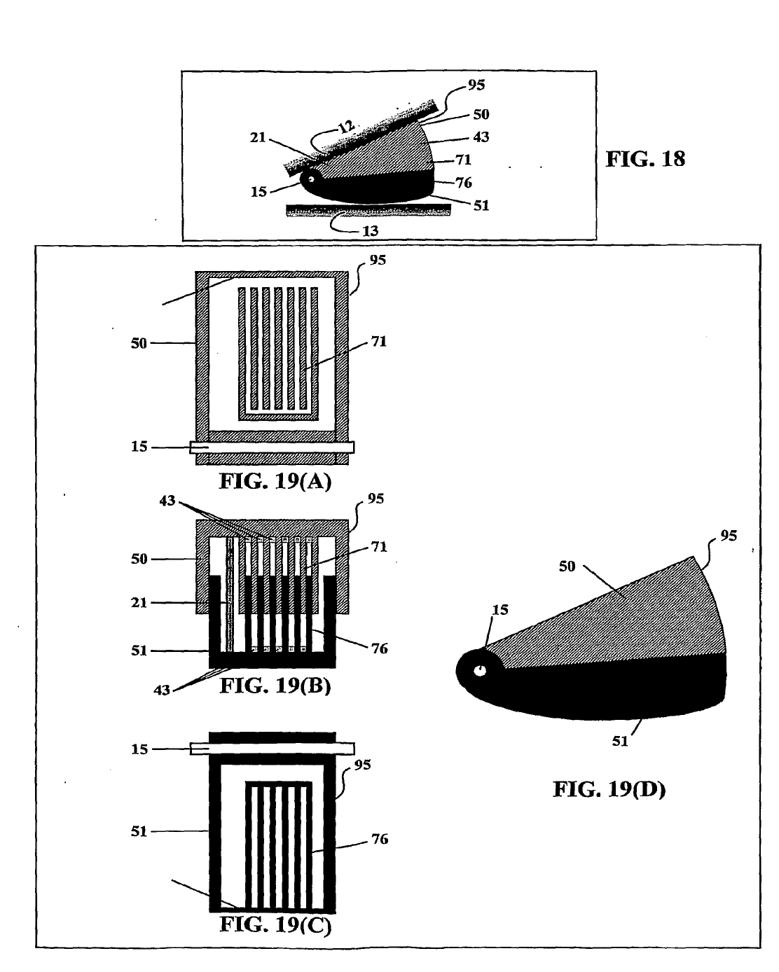

Referring to FIG. 18, an example hinged dilatant-lubricant-based anti-rock leg device 95 is provided. The device 95 includes a first member 50 and a second member 51 and a hinge 15. A spring 21 comprising the primary elastic means and a set of interdigitating sheets 71 and interdigitating slots 76 impregnated with dilatant lubricant 43 comprising the primary damping means act in parallel between, for example, a piece of furniture 12 (or body) and the floor 13 (or body) so that they experience the same strain while sharing the stress. On long timescales, the spring experiences the stress. On short timescales, the dilatant-lubricant-based damping means also experiences stress and acts to oppose changes in strain.

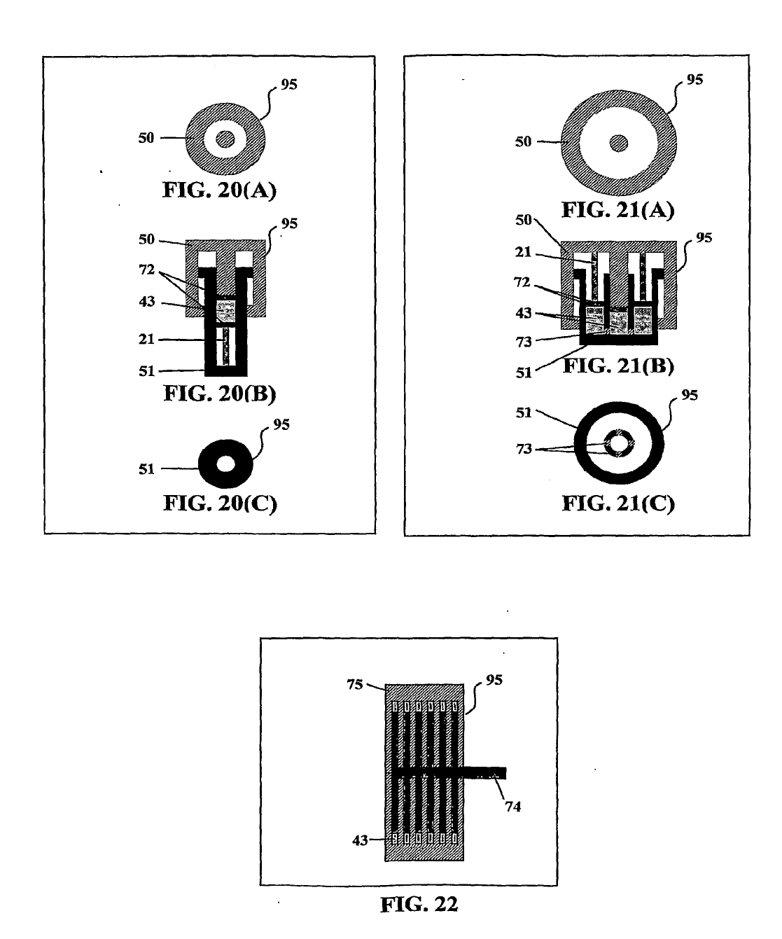

Referring to FIGS. 19(A)-(D), an example hinged dilatant-lubricant-based anti-rock leg device 95 is provided. The device 95 includes a first member 50 and a second member 51 and a hinge 15. A spring 21 comprising the primary elastic means and a set of interdigitating sheets 71 and interdigitating slots 76 impregnated with dilatant lubricant 43 comprising the primary damping means act in parallel between, for example, a piece of furniture 12 (or body) and the floor 13 (or body) so that they experience the same strain while sharing the stress. FIG. 19(A) provides a bottom plan view of the bottom surface of first member 50 and hinge 15. FIG. 19(B) provides an elevational view from the end. FIG. 19(C) provides a top plan view of the top surface of second member 51 and hinge 15. FIG. 19(D) provides an elevational view from the side.

With a hinge 15 at one end, this embodiment opens and closes in response to increasing and decreasing stress, respectively, and can tolerate forces and torques that are not purely compressive. As a result, this embodiment is well-suited to furniture with non-vertical legs (e.g., folding chairs) where torsional influences would impede the proper operation of the legs in embodiment b.6.

This embodiment also illustrates several other important innovations that are part of this invention.

This embodiment is well-suited to furniture pieces with non-vertical legs because it can tolerate the torques associated with non-perpendicular contact between the leg and the ground. Its curved bottom surface allows the embodiment to maintain smooth support even as it hinges open or closed.

As with embodiment b.6, the two-piece case of the hinged embodiment acts as a secondary elastic means. When the device has hinged closed to its maximum extent, the interdigitating sheets and slots come into contact and propel extra dilatant lubricant out into the gaps between those sheets and slots. This contact allows the hinged embodiment to support great weight and to relubricate itself. Moreover, interlocking aspects of the two-piece case of the hinged embodiment prevent the case from opening beyond its maximum extent. Once assembled, the case no longer opens completely and its covers protect the components inside from dirt, dust, or other contamination or contact.

### Embodiment b.8

### Linear Piston Dilatant-Lubricant-Based Anti-Rock Leg, Straight

Referring to FIGS. 20(A)-(C), an example straight linear piston dilatant-lubricant-based anti-rock leg device 95 is provided. The device 95 includes a first member 50 and a second member 51. A spring 21 comprises the primary elastic means and a trapped volume of dilatant lubricant 43 sliding through a cylindrical channel comprises the primary damping means. A sealing gasket 72 can help to trap the dilatant lubricant 43. For example, the floor supports the spring 21, the spring 21 (or coil) supports the trapped volume of dilatant lubricant 43, and the dilatant lubricant 43 supports the furniture. FIG. 20(A) provides a bottom plan view of the bottom surface of first member 50. FIG. 20(B) provides an elevational view. FIG. 20(C) provides a top plan view of the top surface of second member 51.

On long timescales, the stacked spring and lubricant act elastically and the spring bears the weight of the furniture, assisted by the case (which provides the leg with a maximum and minimum length). On short timescales, the trapped dilatant lubricant acts as a damping means and opposes changes in strain.

### Embodiment b.9

### Linear Piston Dilatant-Lubricant-Based Anti-Rock Leg, Folded

Referring to FIGS. 21(A)-(C), an example folded linear piston dilatant-lubricant-based anti-rock leg device 95 is provided. The device 95 includes a first member 50 and a second member 51. This embodiment is closely related in concept to embodiment b.8, except that it has been “folded” in order to make it shorter. Again, a sealing gasket 72 can help to trap the dilatant lubricant 43. The trapped volume of dilatant lubricant 43 now slides down a central cylinder and up an annular surrounding cylinder, or vice versa. Channels 73 can facilitate this motion. The spring 21 (or coil) still acts to cause the level of the dilatant lubricant 43 in the central cylinder to rise and the weight of the furniture still acts to cause the level of the dilatant lubricant 43 in the central cylinder to fall. The spring 21 now bears some of the furniture's weight directly and therefore acts twice as the elastic means, much the way a multiple pulley system uses the tension in its rope several times to support a heavy object. FIG. 21(A) provides a bottom plan view of the bottom surface of first member 50. FIG. 21(B) provides an elevational view. FIG. 21(C) provides a top plan view of the top surface of second member 51 and channels 73.

On long timescales, the spring dominates the dynamics of this folded system and the system acts elastically: the spring bears the weight of the furniture, assisted by the case (which provides the leg with a maximum and minimum length). On short timescales, the trapped dilatant lubricant acts as a damping means by way of severe viscous drag and opposes changes in strain.

### Embodiment c.1

### Rotary Dilatant-Lubricant-Based Device

Referring to FIG. 22, an example rotary dilatant-lubricant-based device 95 is provided. A rotating component or “rotor” 74 resides in a stationary component or “stator” 75 and the two are separated in various places by dilatant lubricant 43. When the rotor 74 turns slowly in the stator 75, it experiences weak damping forces or torques. When the rotor 74 turns quickly in the stator 75, it experiences strong damping forces or torques. This embodiment includes the inverted variant in which the central component acts as the stator 75 and the peripheral component acts as the rotor 74.

Applications of this embodiment include speed governors, gradual release and timed release rotary systems, and rate limiters in rotary devices.

### Embodiment c.2

### Linear Dilatant-Lubricant-Based Viscoelastic Device 1

The viscoelastic portion of embodiment b.6, consisting of the interdigitating parts of the two case components, the dilatant lubricant, and the spring, is itself a general embodiment of the invention, independent of its application to furniture legs. In this general embodiment, the invention is a device that behaves elastically when exposed to compressive or tensile stresses on long timescales but exhibits elevated rigidity on short timescales. It acts as a soft, elastic system when its motion is slow and a firm system when its motion is fast. Similarly, a variant of Embodiment c.2, Embodiment c.2a, consists of the viscoelastic elements of Embodiment b.6a.

### Embodiment c.3

### Linear Dilatant-Lubricant-Based Viscoelastic Device 2

The viscoelastic portion of embodiment b.7, consisting of the trapped lubricant, the cylinder surrounding it, the spring, and the seals, is itself a general embodiment of the invention, independent of its application to furniture legs. In this general embodiment, the invention is a device that behaves elastically when exposed to compressive or tensile stresses on long timescales but exhibits elevated rigidity on short timescales. It acts as a soft, elastic system when its motion is slow and a firm system when its motion is fast. The viscoelastic portion of embodiments b.8 and b.9 are similarly of general utility as their own embodiments of the invention.

### Embodiment c.4

### Slowing Lubricant

This embodiment of the invention is the application of a dilatant lubricant to an existing device wherein that dilatant lubricant is expected to act as a lubricant for slow motions and an anti-lubricant for fast motions.

To improve wetting between the dilatant lubricant and the objects involved, or to help disperse the dilatant lubricant into those objects, that dilatant lubricant can be softened with or dissolved in a volatile solvent. (e.g., Silly Putty®, Dow Corning 3179 Dilatant Compound, and Dow Corning Q2-3233 Bouncing Putty can be softened or dissolved in isopropanol). The full dilatant character of the lubricant will return once the solvent has evaporated.

### Embodiment c.5

### Self-Releasing Adhesive

This embodiment of the invention is the application of a dilatant lubricant to act as a self-releasing adhesive. When placed between two objects so that it makes substantial contact with both objects, this self-releasing adhesive binds those objects together on short timescales, but acts as a lubricant on long timescales. It holds the objects together only temporarily and gradually releases them from one another. This embodiment has applications to timed release and delayed release systems. It can be used to post notices that remain in place temporarily, but drop off after a certain amount of time.

To improve wetting between the dilatant lubricant and the objects to be bound together temporarily, that dilatant lubricant can be softened with or dissolved in a volatile solvent. (e.g., Silly Putty®, Dow Corning 3179 Dilatant Compound, and Dow Corning Q2-3233 Bouncing Putty can be softened or dissolved in isopropanol). The full dilatant character of the lubricant as a temporary adhesive will return once the solvent has evaporated.

### Embodiment d.1

### Hard Stop Addition

While any elastic means will eventually reach its natural minimum length, a typical elastic means can be damaged by excessive stress. To protect the primary elastic means used in any embodiment of this invention, an additional hard stop can be incorporated as a secondary part of the elastic means. Referring to FIG. 10, a hard stop 63 can be added to the embodiment of an elastic means 20 and a damping means 40 in communication with one or more bodies, for example, a piece of furniture 12 (or body) and the floor 13 (or body). As shown, this hard stop 63 acts as a highly nonlinear portion of the overall elastic means.

For small strains, the hard stop 63 does not contribute to the stress. At a certain strain, however, the hard stop 63 makes contact and begins to contribute to the stress. It gives the embodiment a “bottoming out” behavior: once the strain exceeds a certain value, the stress increases dramatically. In the context of an anti-rock leg, the hard stop 63 effectively prevents the leg from shortening beyond a certain minimum length, established by that hard stop 63.

In situations where an embodiment of this invention is retrofitted on an existing piece of furniture, it could take the form of an anti-rock leg installed adjacent to the original rigid leg. The anti-rock leg would be longer than the original leg in normal situations, so the piece would normally be supported by the anti-rock leg and the original leg would not contact the floor. When the long-timescale burden placed on the anti-rock leg exceeded a certain value, however, it would shorten far enough that the original leg would contact the floor and acts as a hard stop.

### Embodiment d.2

### Case Addition

The case addition embodiment shown in FIG. 11 offers several important features to make an anti-rock leg more robust and useful. This embodiment still includes an elastic means 20 and a damping means 40 in communication with one or more bodies, for example, a piece of furniture 12 and the floor 13. Composed of a hard material such as metal or plastic, the case 64 or the like consists of two half-shells: one attached to the piece of furniture 12 and opening downward, and one touching the floor 13 and opening upward. One of the half-shells of the case 64 slides freely within the other. The two half-shells of the case 64 may interlock (as shown) so that they cannot be separated from one another completely. That interlocking may be permanent (e.g., due to crimping, riveting, bending, or other mechanical alteration) or it may be temporary (e.g., as the result of a bayonet style insert, twist, and lock arrangement). The two half-shells of the case 64 have a minimum length beyond which they act as a hard stop, as discussed in embodiment c.1. If the two half-shells of the case 64 interlock, then they have a maximum length beyond which they oppose further decreases in strain by exerting an increasing negative stress. In short, they oppose overextension.

The primary elastic means and the damping means are housed within this case embodiment and may or may not be fixed in place (e.g., by gluing, welding, riveting, bolting, or any mechanical alteration). The case 64 itself acts as a secondary elastic means, causing the stress to increase dramatically once the strain exceeds a certain maximum or decrease dramatically once the strain drops below a certain minimum (if the half-shells are interlocking).

In the context of an anti-rock leg, this case provides an attachment surface for connecting the leg to the piece of furniture, a sturdy wear surface for contacting the floor, a hard stop to prevent the leg from shortening beyond a certain minimum length, and a protective housing for the primary elastic means and damping means contained within it.

### Embodiment d.3

### Rigid Leg/Anti-Rock Foot

In the context of anti-rock legs, this invention will often be realized as a retrofit or replacement foot on existing furniture legs or as an original foot on newly constructed furniture. In such circumstances, embodiments of this invention take the composite form shown in FIG. 12.

In this embodiment, the overall elastic means 20 consists of the rigid leg 23 and the elastic portion of the anti-rock foot 90. The damping means 40 is contained entirely in the foot. The elastic means 20 and the damping means 40 may be in communication with one or more bodies, for example, a piece of furniture 12 and the floor 13.

In its embodiment as a rigid leg 23 with an anti-rock foot 90, this invention has a number of simple top and bottom surface accessories that make it easier to use. To attach the anti-rock foot 90 to the rigid leg 23, the anti rock-foot's 90 upper surface can have a threaded extension, a self-adhesive patch, and/or an indentation to accommodate the rigid leg's 23 existing foot.

As with any embodiment of this invention as an anti-rock leg, the anti-rock foot's lower surface can have a non-slip coating to impede sliding, an easy glide coating to facilitate sliding, a caster assembly to permit rolling, or a mechanical structure with which to attach it to the floor to prevent movement and allow the anti-rock foot to experience negative stresses.

### Embodiment d.4

### Adjustable Elastic Means and/or Damping Means

This invention encompasses embodiments in which the elastic means and/or the damping means have adjustable characteristics. In the context of anti-rock legs, an adjustable elastic means allows the anti-rock leg to change its long timescale response to furniture weight, and an adjustable damping means allows the anti-rock leg to change its short timescale response to changes in furniture weight, center of gravity, and external forces.

For example, the embodiment shown in FIG. 13 has an adjustable damping means; it incorporates a bypass pipe and bypass valve 65 into a shock absorber 62. Opening the bypass valve 65 reduces the shock absorber's 62 opposition to changes in strain and thereby softens the device's short timescale behavior. The device can be rendered firm on a short timescale by fully closing the valve, soft on a short timescale by fully opening the valve, and everything in between by adjusting the valve appropriately. The elastic means 20 and the shock absorber 62 may be in communication with one or more bodies, for example, a piece of furniture 12 and the floor 13.

In the context of anti-rock legs, softening an embodiment of this invention temporarily will allow it to adapt to the current distribution of weight quickly. Once the legs have adapted to their proper lengths, the firmness can be reintroduced to prevent bouncing.

### Embodiment d.5

### Multiple-Elastic Means and/or Damping Means Embodiment

Various aspects of embodiments of this invention encompasses embodiments in which the elastic means and/or the damping means are subdivided into two or more pieces, including the embodiment shown in FIG. 14. In that embodiment, the elastic and damping means take the form of two or more balls of composite material 9 that comprises both the elastic means and damping means. In this embodiment, the balls are located inside a case 64 to keep them in place and to protect them from injury and wear. The balls of composite material 9 and the case 64 may be in communication with one or more bodies, for example, a piece of furniture 12 and the floor 13.

The individual balls of composite material 9 can be free inside the case 64, or held in place by glue, foam, or any other mechanical restraints. The case 64 or the like can be sealed permanently, or it can be made openable so that the individual balls can be replaced. Choosing balls with different characteristics (e.g., firmer or softer elastic means and/or damping means) allows the device to be customized to its particular task.

There are several non-limiting advantages to this distributed elastic-damping means approach. First, the embodiment can be made extremely thin, an important feature when retrofitting anti-rock feet onto existing pieces of furniture. Second, the embodiment can be made extremely reliable because it can continue to work even if one or more of its individual balls fails to function properly. Third, the embodiment can be made with an arbitrarily large or small cross-sectional area (i.e., the area of contact with the floor).

### B. Specific Applications

The anti-rock leg is one embodiment of the invention: it provides the piece of furniture to which it is attached with soft elastic support on long timescales, allowing the piece to adapt to any imperfections in the floor or the piece itself, and it provides the piece with firm support on short timescales, thereby preventing the piece from bouncing and giving it a firm and sturdy feel.

In addition to supporting pieces of furniture, these anti-rock legs can act to prevent rocking and to distribute weight evenly in a variety of other situations, including but not limited to: appliances, equipment (household, commercial, and industrial), art objects, vehicles, packages, containers, computers and other electronic devices, carts, and dollies.

There are, however, many other devices that embody the invention. They include, but not limited thereto, the following:

### B.1 Devices to Prevent Cargo or the Like from Shifting

Cargo on a truck, airplane, train, or ship can shift during a sudden acceleration when inertial effects overwhelm the forces of static friction. The consequences of such a shift can be disastrous. Restraining the cargo is therefore extremely important.

Conventional restraints, however, are purely elastic, meaning that they exert the same forces on the cargo at long timescales as they do at short timescales. Since large forces are required to prevent cargo from sliding during sudden accelerations, conventional restraints must exert large forces on the cargo at all times. These large forces can crush or deform the cargo and are undesirable.

By restraining cargo with embodiments of this invention, the cargo can be subjected to modest long timescale forces while still experiencing the strong short timescale forces necessary to keep it from sliding during sudden accelerations. Devices embodying this invention could be inserted between the cargo and the walls of its container and allowed to lengthen until they restrain the cargo gently at long timescales. During sudden accelerations, however, the devices would exert strong restraining forces on the cargo. Rotary embodiments of this invention could also be used, rotating spontaneously against the cargo to provide it with gentle long timescale restraint forces (or torques) while offering strong short timescale restraining forces (or torques) during sudden accelerations. Adjustment systems to soften the elastic means and/or the damping means could be activated temporarily to facilitate loading and unloading of cargo.

### B.2 Support for Cameras and Other Devices that Require Short-Timescale Rigidity

Cameras are traditionally mounted on tripods because a three-legged tripod can't rock in our three-dimensional world. But tripods don't work in all situations or with devices that need a broader or more complicated base of support. This invention can be used to achieve the high level of short timescale rigidity needed for cameras and other devices or instruments in situations where tripods or supports are not suitable.

### B.3 Inserts and Mounts that Eliminate Rattle, Chatter, Hum, and Buzz

Our world is full of objects that rattle, chatter, hum, and buzz when exposed to vibrations, wind, jostling, or noise. This rattling, chattering, humming, and buzzing is the result of unconstrained motion—the objects are loose and unable to avoid moving in response to external forces or inertial effects. Examples of this annoying behavior include:

1. Doors and windows that are rattled by the wind.

2. Appliances and fans that chatter while their motors are operating

3. Transformers and ballasts that hum or buzz when they are active

4. Vehicle components that rattle when driving on rough pavement

These motions can be eliminated by applying conventional restraints, e.g., by inserting wedges into rattling doors or windows, bolting appliances and fans to the floor, clamping transformers and ballasts into place, and screwing automobile components down tightly.

But conventional restraints are purely elastic and therefore exert the same forces at long timescales as they do at short timescales. Those restraints must therefore exert large restraining forces at all times, even though rattling, chattering, humming, and buzzing are short timescale phenomena. Providing large static forces typically requires extremely stiff restraints (e.g., metal bolts and plastic wedges) that can accommodate only a narrow range of strains. In other words, they must be inserted or tightened carefully because there isn't much distance separating looseness from breakage. Moreover, these purely elastic constraints easily loosen over time, letting the rattle, chatter, hum, or buzz that they were meant to prevent reappear.

Restraints embodying this invention, on the other hand, eliminate rattling, chattering, humming, and buzzing without exerting large restraining forces on long timescales. They can provide the strong short-timescale forces needed to control rattling, chattering, humming, and buzzing while exerting only moderate long-timescale forces. Furthermore, they can adapt to changes in the situation.

A device embodying this invention won't loosen or break because it will adapt to the room allotted to it. For example, a device embodying this invention could be inserted into the gap between a window and the window frame, where it would increase in length until it restrained the window gently but snugly. When the wind acts to shake the window, the window won't rattle because the device will exert the strong short-timescale forces necessary to prevent the window from responding to the wind.

Similarly devices embodying this invention could be incorporated into the mounts for motors, fans, appliances, transformers, ballasts, and automobile components, where those devices would continually adapt to their situation while steadily opposing chatter, rattle, hum, and buzz.

Additionally, an embodiment of this invention can be gradually shortened by exerting stress on it manually until it is easily small enough to be inserted into a gap. It will then spontaneously lengthen until it fills that gap. Once in place, it will continue to fill that gap indefinitely and always respond in a firm manner to short timescale influences. For example, an embodiment of this invention consisting of a spherical piece of composite material can be squeezed slowly into a thin oval shape and then slid into the gap between a window and a window frame. This device will gradually return toward its original spherical shape but find itself constrained between the window and window frame. It will continue to fill that gap indefinitely and will exert strong forces to opposite any sudden movements of the window toward the window frame.

### B.4 Self-Adjusting Doorstops and Other Detents

Spring-loaded doors are often held open by restraints that are elastic at best, plastic (i.e., permanently deformable) at worst. Rubber doorstops, being elastic, work reasonably well. Wooden doorstops, being partly elastic and partly plastic, work less well. These conventional restraints cannot adapt to changes in the situation. Uneven flooring, an accidental bump, or a gust of wind can knock one of them loose and let the door close.

A device embodying this invention, however, could adapt to the situation and restrain the door indefinitely without loosening. The device will gradually swell to fill the gap available to it while providing the strong short timescale forces needed to restrain the door against bumps or the wind.

In addition to self-adapting doorstops, devices embodying this invention can be used as self-adapting detents in other situations. Damping means having extreme properties can extend the adaptation times for these devices to months or even years. “Long timescale” would then refer to months or years, while “short timescale” would refer to weeks or shorter. A door latch employing such a device would feel stiff and solid to any casual observer and would restrain the door sturdily. But as the door structure ages and deforms over the course of months or years, the latch would gradually adapt to fit it.

### B.5 Load-Distributing and Gap-Filling Surfaces

When you place a rigid object on a rigid floor, the object will be supported at only a few contact points with the floor. That's because neither the object's bottom surface nor the floor's top surface is perfectly flat and their rigidities prevent them from accommodating each others' imperfections. Their surfaces need some amount of elasticity to undergo that accommodation. In effect, one or both of them has to give.

If they give elastically (i.e., without damping), they'll become softer at all timescales. In other words, to allow the object to rest on the floor so that it touches the floor more or less everywhere, one or both of them has to become relatively soft. It will exhibit that softness no matter how quickly or slowly you push on it. To accommodate a particular non-flat, rigid object, the floor must be particular soft and it will feel soft and bouncy all the time. A conventional bed mattress exemplifies such a soft, bouncy “floor.”

Soft and bouncy is good for sleeping people, but sometimes it's important to have an adaptable surface that does not feel soft or bouncy at short timescales.

A surface embodying this invention is comprised of an extended elastic means and an extended damping means and (1) gradually thickens wherever the stress per unit of surface area it experiences is small, zero, or negative, (2) gradually thins wherever the stress per unit of surface area it experiences is large, (3) opposes any sudden changes in thickness, and (4) is intended to provide relatively soft elastic support on a long timescale and relatively firm support on a short timescale.

A surface embodying this invention will adapt to the contours of whatever object is placed on it while providing that object with firm, non-bouncy support. That support will be distributed relatively evenly across the object's bottom and there will be few gaps between the object and the supporting surface. The near absence of gaps between supporting surface and object improves their thermal contact, their electrical contact, and their ability to exclude liquids and gases.

### B.6 Self-Adjusting Seals

Gaps between surfaces are conventionally filled with normal elastic materials. For example, the space between windows, frames, doors, ducts, and vents are generally sealed by stuffing elastic materials into them. Those elastic materials, however, must be (1) narrow enough to allow them to slide into the gaps yet (2) wide enough to accommodate variations in the gap along its length and to maintain the seal for years despite changes in environment and aging of the objects they seal. Those conflicting requirements often lead to seal failures.

A sealing material embodying this invention, however, can be thick enough to easily seal a given gap for years yet able to adopt a narrow width long enough for straightforward insertion into that gap. For example, a composite material embodiment of the invention can be dispensed as a narrow, squeezed strip and inserted into a gap. It will then widen back toward its equilibrium width and tightly seal the gap at each point along its length. Its large dynamic range of widths will allow it continuing sealing the gap even as the gap evolves with time. This embodiment will also supply firm, short-timescale support to the objects forming the gap.

### B.7 Simple Weighing Devices

Pitchers and dispensers change weight during use and it is often desirable to know their approximate weights so as to be able to judge how much material they contain. For example, being able to see at a glance how much milk there is in a pitcher would allow a person working in a coffee shop to know when it is time to refill that pitcher.

The weight of the container can be measured by supporting it on an elastic means and observing the height of that means. But to avoid undesirable bounciness, the elastic means must be quite firm and its height will therefore change little as the container's contents change. Any weight indicator based on the height of that elastic means will have to be extremely sensitive and therefore relatively complicated.

Supporting the container on an embodiment of the invention, however, will make it easy to determine the container's weight while avoiding bounciness. Its elastic means can be soft enough to change height significantly as the container's contents change while its damping means prevents the container from bouncing. For example, feet made from the composite material could be attached to the bottom of the container so that they are compressed and hidden from view while the container is full and are only tall enough to become visible when the container is nearly empty.

### B.8 Other Applications and Uses

There are many other applications and uses of the composite material. In the context of anti-rock feet, the composite can serve as the basis for both linear and hinged anti-rock feet. The composite can be incorporated in practical anti-rock feet using sequential or co-injection molding of case and composite.

In other context, the composite material can function as an expanding wedge; restraints for cargo; supportive and load-distributing padding; gap-filling padding; protective gear; shoe inserts; toys (i.e., bouncing balls); stick-on feet for nick-nacks; dilatant lubricant devices (linear or torsional, including ratchet spring); anti-vibration inserts for ballasts, transformers, etc.; anti-rattle inserts or wedges for vehicles, etc.; self-adjusting detents; and weight indicators for dispensers and pitchers.

### C. Summary

In summary, in the context of furniture, or other applicable objects, this invention takes the form of anti-rock furniture legs (or other segments) that solve the rocking table problem once and for all. These anti-rock legs are self-adjusting and ensure that any piece of furniture they support is always resting on all of its legs. A piece of furniture that has these anti-rock legs never rocks and always feels firmly and sturdily supported. Moreover, the anti-rock legs offer the additional benefit of distributing the piece's weight relatively evenly among the legs.

These anti-rock legs are simple, passive devices that are robust, reliable, compact, and easy and inexpensive to manufacture. They can be retrofitted on existing furniture and can have any type of floor contact, including non-skid floor contacts, easy glide floor contacts, and casters. They are well-suited to virtually all pieces of furniture, as well as to appliances, equipment (household, commercial, and industrial), art objects, vehicles, packages, containers, computers and other electronic devices, carts, and dollies.

In other contexts, this invention takes the form of self-adjusting restraints and supports. It can prevent cargo from shifting during transit, it can prevent rattling, chatting, humming, and buzzing in doors, windows, motorized equipment, vehicle components, transformers, and ballasts. In all cases, it is self-adjusting and gentle, so that it continuously perfects its restraint and support characteristics, all without any external intervention. It can provide self-adjusting surfaces that provide even but firm support for non-flat objects. It can optimize contact between two surfaces to maximize thermal contact, electrical contact, and gas and liquid exclusion. It can also act as a seal with a large dynamic range of widths.

Some exemplary products and services that may be associated with various aspects of various embodiments of the present invention may include, but are not limited thereto, the following:
1. Anti-rock furniture legs (or other bodies and objects or segments of bodies and objects)
2. Anti-rock feet for existing furniture or bodies/objects.
3. Anti-rock casters for existing furniture or bodies/objects.
4. Load-balancing, anti-rock, short-timescale-firm legs for equipment, devices or instruments.
5. Self-adjusting cargo restraints for transport, mobile, or transfer applications.
6. Self-adjusting inserts and mounts to prevent rattling, chattering, humming, and buzzing in doors, windows, motorized equipment, vehicle components, transformers, ballasts, or any desired structures or equipment, etc.
7. Self-adjusting doorstops and other detents, even those requiring extremely slow self-adjustments (e.g., a door closure that adapts to the aging door and door frame).
8. Self-adjusting surfaces that provide even but firm support for irregular objects.
9. Self-adjusting surfaces that maximize mechanical, thermal and electrical contact, while also excluding gas and liquid.
10. Self-adjusting seals that can be squeezed to narrow dimensions for insertion in gaps and that will expand to seal those gaps reliably and with firm support at short timescales.

Some non-limiting exemplary advantages that may be associated with various aspects of various embodiments of the present invention may include, but not limited thereto, the following:
These self-adjusting devices are simple, effective, reliable, robust, easy and inexpensive to manufacture, and safe.
Although they can be customized to specific applications, a typical device has a broad range of functionality and a nearly one-size-fits-all character.
They can be disposable, reusable, or permanent.
They can be made on all size scales from millimeters to meters.

The composition, devices, systems and methods of various embodiments of the invention disclosed herein may utilize aspects disclosed in the following patents and are hereby incorporated by reference in their entirety:

U.S. Pat. No. 2,431,878 to McGregor;
U.S. Pat. No. 2,541,851 to Wright;
U.S. Pat. No. 2,704,663 to Blake;
U.S. Pat. No. 3,045,390 to Tao;
U.S. Pat. No. 5,042,764 to Carpinella et al.;
U.S. Pat. No. 5,042,765 to Widerstrom,
U.S. Pat. No. 5,165,636 to Grissom;
U.S. Pat. No. 4,371,636 to Distler et al.;
U.S. Pat. No. 4,654,396 to Bung et al.;
U.S. Pat. No. 5,037,880 to Schmidt et al.;
U.S. Pat. No. 6,946,138 to Iwai et al.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. A composite material comprising:
viscous material dispersed in elastomer material.

2. The composite material of claim 1, wherein said viscous material comprises a dilatant material.

3. The composite material of claim 2, wherein said dilatant material is silicone based.

4. The composite material of claim 2, wherein said dilatant material is at least one of the following:
silicone-based substance;
white glue and borax (or boric acid);
polyvinyl alcohol, water, and borax (or boric acid);
starch and water;
starch, water, and borax (or boric acid);
silica nanoparticles in ethylene glycol (or another liquid);
copolymer dispersions; and
oil/water/polymer emulsions.

5. The composite material of claim 1, wherein said viscous material is dispersed via spontaneous phase separation.

6. The composite material of claim 1, wherein said viscous material is dispersed via mechanical separation.

7. The composite material of claim 1, wherein said viscous material is dispersed via a combination of spontaneous phase separation and mechanical separation.

8. The composite material of claim 1, wherein said viscous material is dispersed in at least one of a particulate structure, threaded structure, layered structure, or pocketed structure.

9. The composite material of claim 1, wherein the dispersion of said viscous material in said elastomer material is stabilized or facilitated by at least one surfactant.

10. The composite material of claim 1, wherein said elastomer material is at least one of meltable material, cureable material, or vulcanizable material.

11. The composite material of claim 10, wherein said meltable material is a thermoplastic material.

12. The composite material of claim 10, wherein said meltable material is at least one of the following:
styrene butadiene styrene (SBS) elastomer;
styrene isoprene styrene (SIS) elastomer;
styrene ethylbutylene styrene (SEBS) elastomer;
ethylene propylene rubber (EPR);
polypropylene/rubber dynamic vulcanizates (DV);
plasticized polyvinyl chloride (PVC) elastomers;
chlorinated olefin interpolymer alloy;
polyurethane (PU) elastomer;
polyester (PEst) elastomer; and
polyamide (PA) elastomer.

13. The composite material of claim 10, wherein said cureable material is a thermoset.

14. The composite material of claim 10, wherein said cureable material is at least one of the following:
silicone rubber;
fluorosilicone rubber;
polyisoprene rubber;
polychloroprene rubber;
nitrile rubber;
polyvinyl chloride (PVC) rubber;
ethylene propylene diene monomer (EPDM) rubber; and
polyurethane (PU) elastomer.

15. The composite material of claim 10, wherein said vulcanizable material is a thermoset.

16. The composite material of claim 10, wherein said vulcanizable material is at least one of the following:
classic rubber;
natural rubber;
silicone rubber;
fluorosilicone rubber;
polyisoprene rubber;
polychloroprene rubber;
nitrile rubber;
polyvinyl chloride (PVC) rubber;
ethylene propylene diene monomer (EPDM) rubber; and
polyurethane (PU) elastomer.

17. The composite material of claim 1, wherein:
said elastomer material comprises styrene ethylbutylene styrene (SEBS) elastomer; and
said viscous material is silicone based.

18. The composite material of claim 17, wherein said styrene ethylbutylene styrene (SEBS) elastomer comprises Kraton G-1657.

19. The composite material of claim 17, wherein said silicone based material comprises heat treated silanol-terminated silicone oil, boric acid, and 5 micron silica.

20. The composite material of claim 19, wherein said heat treated silanol-terminated silicone oil comprises Gelest DMS-S27.

21. The composite material of claim 1, wherein:
said elastomer material comprises polyurethane (PU) elastomer; and
said viscous material is silicone based.

22. The composite material of claim 21, wherein said polyurethane (PU) elastomer comprises Freeman 1040.

23. The composite material of claim 21, wherein said silicone based material comprises heat treated silanol-terminated silicone oil, boric acid, and 5 micron silica.

24. The composite material of claim 23, wherein said heat treated silanol-terminated silicone oil comprises Gelest DMS-S27.

25. The composite material of claim 1, wherein said composite material is in communication with a first body and a second body.

26. The composite material of claim 25, wherein said first body and said second body may include at least one of the following:
floor; ground; wall; piece of furniture; appliance; container; household equipment; commercial equipment; industrial equipment; art object; vehicle; computer; electronic device; cart; dolly; camera; camera mount; door; door frame; window; window frame; motor; fan; transformer; ballast; automobile component; ratchet; cargo; shoe; lever; switch; button; subfloor; inner wall; tile; marble; granite; slate; or wood.

27. The composite material of claim 25, wherein said first body may include cargo and said second body may include anything that may communicate with said cargo.

28. The composite material of claim 25, wherein the communication between said composite material and one or both of said first and second bodies is mediated by at least one of the following:
container; shell; holder; retainer; clip; clamp; housing; guard; spring; or covering.

29. The composite material of claim 28, wherein said container, shell, holder, retainer, clip, clamp, housing, guard, spring, or covering contributes to at least one of:
the elastic character of said composite material and the viscous character of said composite material.

30. The composite material of claim 25, wherein said composite material serves as an adhesive to bind said first body to said second body.

31. The composite material of claim 25, wherein said composite material serves as a seal or gasket between said first body and said second body.

32. The composite material of claim 25, wherein said composite material has a shape or thickness that is used to measure the forces exerted between said first body and said second body.

33. A method of manufacturing a composite material, said method comprising:
providing elastomer material; and
dispersing viscous material into said elastomer material.

34. The method of claim 33, said dispersing comprising:
melting said elastomer material; and
mixing said viscous material and said melted elastomer material together.

35. A method of manufacturing a composite material, said method comprising:
providing at least one precursor material;
dispersing viscous material into said at least one precursor material; and
transforming said at least one precursor material into an elastomer material.

36. The method of claim 35, wherein said transforming comprises polymerizing said at least one precursor material.

37. The method of claim 35, wherein said transforming comprises cross-linking said at least one precursor material.

38. The method of claim 35, wherein said transforming comprises polymerizing and cross-linking said at least one precursor material.

39. The method of claim 35, wherein said dispersing comprises at least one of the following:
mixing;
cutting and mixing;
grinding and mixing;
powdering and mixing; and
pulverizing and mixing.

40. The method of claim 39, wherein said powdering or pulverizing is provided using a brush at high speeds in contact with said viscous material.

41. The method of any of claims 33 or 35, further comprising;
providing a first body in communication with said composite material; and
providing a second body in communication with said composite material.

42. The method of claim 41, wherein said first body and said second body may include at least one of the following:
floor; ground; wall; piece of furniture; appliance; container; household equipment; commercial equipment; industrial equipment; art object; vehicle; computer; electronic device; cart; dolly; camera; camera mount; door; door frame; window; window frame; motor; fan; transformer; ballast; automobile component; ratchet; cargo; shoe; lever; switch; button; subfloor; inner wall; tile; marble; granite; slate; or wood.

43. The method of claim 41, wherein said first body may include cargo and said second body may include anything that may communicate with said cargo.

44. The method of claim 41, wherein the communication between said composite material and one or both of said first and second bodies is mediated by at least one of the following:
container; shell; holder; retainer; clip; clamp; housing; guard; spring; or covering.

45. The method of claim 44, wherein said container, shell, holder, retainer, clip, clamp, housing, guard, spring, or covering contributes to at least one of:
the elastic character of said composite material and the viscous character of said composite material.

46. The method of claim 41, wherein said composite material serves as an adhesive to bind said first body to said second body.

47. The method of claim 41, wherein said composite material serves as a seal or gasket between said first body and said second body.

48. The method of claim 41, wherein said composite material has a shape or thickness that is used to measure the forces exerted between said first body and said second body.

49. A device for opposing rapid relative motion of a first member and a second member, wherein
said first member comprises a dilatant-based material; and
said second member is in contact and movement with said first member.

50. The device of claim 49, wherein said second member comprises a dilatant-based material.

51. The device of claim 49, wherein said dilatant-based material coats said first member.

52. The device of claim 49, wherein said dilatant-based material is dispersed in said first member.

53. The device of claim 49, wherein said dilatant-based material is dispersed in said first member to form a composite material.

54. The device of claim 52, wherein said dilatant-based material is dispersed in said first member via spontaneous phase separation.

55. The device of claim 52, wherein said dilatant-based material is dispersed in said first member via mechanical separation.

56. The device of claim 52, wherein said dilatant-based material is dispersed in said first member via a combination of spontaneous phase separation and mechanical separation.

57. The device of claim 52, wherein said dilatant-based material is dispersed in said first member in at least one of a particulate structure, threaded structure, layered structure, or pocketed structure.

58. The device of claim 49, wherein said first member and said second member comprise interdigitating units.

59. The device of claim 49, wherein said first member and/or said second member may include at least one of the following:
cylinder; piston; pipe; tube; sheet; case; floor; wall; hinge; rotor; stator; leaf spring; coil spring; screw; bolt; or nut.

60. The device of claim 49, wherein said first member or said second member is in communication with a body.

61. The device of claim 60, wherein said body may include at least one of the following:
floor; ground; wall; piece of furniture; appliance; container; household equipment; commercial equipment; industrial equipment; art object; vehicle; computer; electronic device; cart; dolly; camera; camera mount; door; door frame; window; window frame; motor; fan; transformer; ballast; automobile component; ratchet; cargo; shoe; toilet; lever; switch; button; subfloor; inner wall; tile; marble; granite; slate; or wood.

62. The method of any of claims 33 and 35, wherein said composite material is thermally annealed in its final shape to improve its viscoelastic characteristics and performance.
